(19) United States
(12) Patent Application Publication
(10) Pub. No.: US 2026/0253188 A1
(43) Pub. Date: Aug. 27, 2026

(54) APPARATUS AND METHOD FOR COMPUTATIONAL COMPENSATION OF UNDER-CORRECTED ABERRATIONS

(71) Applicant: Illumina, Inc., San Diego, CA (US)

(72) Inventors: Steven Boege, San Mateo, CA (US); Anindita Dutta, San Francisco, CA (US); Simon Prince, Carlsbad, CA (US); Joseph Pinto, Solana Beach, CA (US); Stanley Hong, Palo Alto, CA (US); Rishi Verma, San Jose, CA (US); Geraint Evans, Cambridge (GB); Jeffrey Gau, San Mateo, CA (US); Yina Wang, San Jose, CA (US)

(73) Assignee: Illumina, Inc., San Diego, CA (US)

(21) Appl. No.: 18/872,549

(22) PCT Filed: May 1, 2024
(86) PCT No.: PCT/US2024/027152

§ 371 Date: Dec. 6, 2024

Related U.S. Application Data
(60) Provisional application No. 63/463,200, filed on May 1, 2023.

(51) Int. Cl. G06T 5/80; G01N 21/64

(52) U.S. Cl. CPC G06T 5/80; G01N 21/6458

(57) ABSTRACT

An apparatus and method to compensate for under-corrected aberrations computationally is disclosed. The system includes an excitation radiation source that emits an excitation beam that is focused on a flow cell surface. More specifically, the excitation beam is focused on either an upper surface, a lower surface, or in a channel between the upper and lower surfaces of the flow cell. As imaging both the upper and lower surfaces simultaneously will result in aberration in at least one of the upper and lower surfaces, aberration correction is useful for dual surface imaging. A processor is configured to determine base calls of irradiated sites that fluoresce within the flow cell. An aberration compensation model is trained to compensate for aberrations in at least one image or image data corresponding to the upper surface, the lower surface, or the channel between the upper and lower surfaces.

### CROSS-REFERENCE TO RELATED APPLICATIONS

This application claims the benefit of U.S. Provisional Patent Application No. 63/463,200, filed May 1, 2023, the disclosure of which is incorporated by reference herein in its entirety.

### BACKGROUND

Currently, imaging systems are used to detect radiation emissions, such as optical fluorescence, from biological material. Detected optical data often includes aberrations that can increase the difficulty of base calling of the biological material. Previous systems have utilized additional optical elements to account for aberrations in detected optical data (e.g., a corrective compensator component).

### SUMMARY

Imaging methods and apparatuses are provided for detecting radiation emissions on a support structure. An optical train includes imaging optics. The imaging optics are configured to focus the optical train towards the support structure. In some embodiments, the support structure is a flow cell. For example, the support structure may be a multi-surface flow cell. The support structure may include a first surface and a second surface. A first emissive component associated with a biological sample may be disposed on the first surface. A second emissive component associated with a biological sample may be disposed on the second surface.

In some embodiments, the optical train may include conditioning optics. The conditioning optics may be configured to generate a substantially linear beam of excitation radiation from an excitation radiation source. For example, the conditioning optics may be configured to combine beams from one or more excitation radiation source(s) and/or modify a geometric pattern of one or more excitation beams (e.g., to form a substantially linear excitation line beam, a square excitation beam, a rectangular beam, etc.). In some embodiments, the optical train may include directing optics. The directing optics may be configured to redirect one or more excitation beams from an excitation radiation source. For example, the directing optics may be configured to redirect one or more excitation beams from an excitation radiation source toward focusing optics. In some embodiments, the directing optics may be configured to redirect one or more excitation beams from an excitation radiation source toward the support structure. Alternatively, or additionally, the excitation radiation source may be configured to direct radiation towards one or more of the first and second emissive components. For example, the excitation radiation source may be configured to direct radiation towards one or more of the first and second emissive components along a radiation line. The radiation line may be configured to reside between the first and second emissive components in some embodiments. The excitation radiation source may be, for example, a laser source, electron beam source, one or more light emitting diodes (LEDs), a plasma source, an arc lamp, a halogen lamp, or any other excitation radiation source. In some embodiments, the radiation may be excitation radiation. The system may include, for example, only one excitation radiation source.

Detection optics may be included in a system or method. In some embodiments, detection optics may be configured to detect radiation emissions. The radiation emissions may be returned to the detection optics from one or more of the first emissive component and the second emissive component. In some embodiments, the first emissive component may be positioned within a first nanowell, such as a fluorophore or multiple fluorophores associated with a first cluster of substantially monoclonal samples within the first nanowell. The second emissive component may be positioned within a second nanowell, such as a fluorophore or multiple fluorophores associated with a second cluster of substantially monoclonal samples within the second nanowell. In some examples, the first nanowell may be in a first pattern and the second nanowell may be in a second pattern. The second nanowell may be different from the first nanowell. The radiation emissions may be returned to an imaging sensor of the detection optics, for example, via one or more portions of the optical train. A translation system may be provided in some embodiments. For example, the translation system may be configured to allow for focusing and/or movement of the support structure before and/or during imaging. The translation system may be configured to perform relative motion between the support structure and the optical train and/or excitation radiation source.

Focusing optics may be included in the optical train. The focusing optics may be configured to focus radiation to a surface of the support structure. For example, the focusing optics may be configured to confocally direct radiation to a surface of the support structure. In some embodiments, the focusing optics may be configured for a single design point for diffraction-limited focusing and imaging. For example, the design point may be located at one or more of the first surface, the second surface, and between the first surface and the second surface of the support structure. The design point may be midway between the first and second surfaces or any percentage of the distance between the first and second surfaces away from the first surface (e.g., 10%, 20%, etc.). In some embodiments, the focusing optics may be defined by a numerical aperture (NA). For example, the numerical aperture may have a value of at least about 0.5, at least about 0.55, at least about 0.6, at least about 0.65, at least about 0.7, at least about 0.75, at least about 0.8, at least about 0.85, at least about 0.9, at least about 0.95, above about 1.0, above about 1.1, above about 1.2, or above about 1.3.In some examples, the focusing optics may be configured to confocally direct radiation in a line, for example by scanning. Radiation emissions may be detected with a time delay integration (TDI) sensor. Alternatively, or additionally, the focusing optics may be configured to scan an area, for example in a two-dimensional excitation illumination pattern. Radiation emissions may be detected by a two-dimensional image sensor.

The system may be configured to generate image data. For example, image data may include one or more of first image data of the first emissive component based on detected radiation and second image data of the second emissive component based on detected radiation. In some embodiments, the detector may be configured to generate image data of the first emissive component when the focusing optics confocally directs radiation to the first emissive component, and/or generate image data of the second emissive component when the focusing optics confocally directs radiation to the second emissive component. Image data of the second emissive component may be generated when the focusing optics confocally directs radiation to the first emissive component. Image data of the first emissive component may be generated when the focusing optics confocally directs radiation to the second emissive component. For example, there may be no need to refocus as both the image data of the first emissive component and the image data of the second emissive component may be generated regardless of where the radiation is directed. The detector may include a charged coupled device (CCD) sensor. For example, the CCD sensor may be configured to generate image data based on photons impacting one or more locations in the detector. In some embodiments, the detector may include one or more of a detector array configured for time delay integration (TDI) operation, a complementary metal oxide semiconductor (CMOS) detector, an avalanche photodiode (APD) detector, and a Geiger-mode photon counter.

The system may include a processor configured to determine base calls (e.g., using a base call algorithm). For example, the processor may be configured to determine base calls of irradiated sites that fluoresce within one or more of the first emissive component and the second emissive component of the support structure. In some embodiments, the processor may be configured to determine base calls using an aberration compensation model. The aberration compensation model may be trained to compensate for aberrations of one or more of the first image data and the second image data.

The processor may be configured to generate one or more of a first reconstructed image of the first image data using and a second reconstructed image of the second image data using the aberration correction model. For example, the aberration correction model may compensate for aberrations in one or more of the first image and the second image. In some embodiments, the processor may be configured to determine one or more of base calls of the irradiated sites that fluoresce within the first emissive component of the support structure and base calls of the irradiated sites that fluoresce within the second emissive component of the support structure. For example, the processor may use a base call algorithm. In some embodiments, a base call algorithm may comprise the aberration compensation model. For example, the processor may be configured to generate an aberration compensation model using one or more of decoding, deep learning, deep learning, deep Fourier channel attention network (DFCAN), optical transfer function (OTF) inversion, point spread function (PSF), iterative deconvolution, linear deconvolution, or nonlinear deconvolution (e.g., Lucy-Richardson). In some embodiments, the processor may be configured to generate one or more of the first image and the second image without the use of a corrective compensator component. For example, the imaging system may not include a corrective compensator component.

The aberration compensation model may include one or more of first coefficients to compensate for the aberrations of the first image data, and second coefficients to compensate for the aberrations of the second image data. For example, the first coefficients may be based on a distance between a point of focus of the focusing optics and the first surface of the support structure. The second coefficients may be based on a distance between the point of focus of the focusing optics and the second surface of the support structure in some examples.

### BRIEF DESCRIPTION OF THE DRAWINGS

FIG. 1 is a diagram of an example imaging system.

FIG. 2 is a diagram of an example semi-confocal line scanning approach to imaging the support structure.

FIG. 3A illustrates an example objective lens that is focused on a bottom surface of a support structure.

FIG. 3B illustrates the example objective lens that is focused on an upper surface of the support structure.

FIG. 4 illustrates an example of a production imaging system for imaging support structures.

FIG. 5 depicts an example of base calling.

FIG. 6A and FIG. 6B illustrate examples of images taken of two surfaces of a support structure, where the images have spherical aberrations.

FIG. 7 illustrates a schematic diagram of a system.

FIG. 8 illustrates an example of AI-driven aberration correction of sequencing images using a CNN-based image to image autoencoder model.

FIGS. 9A and 9B illustrate example results of base calling based on various levels of defocus.

FIG. 10 is a block diagram of an example computer system.

FIG. 11 is a flow diagram of an example procedure for determining base calls of irradiated sites that fluoresce within the emissive components of the support structure using an aberration compensation model.

FIG. 12 is a flow diagram of an example procedure for determining base calls of irradiated sites that fluoresce within the emissive components of the support structure using an aberration compensation model.

### DETAILED DESCRIPTION

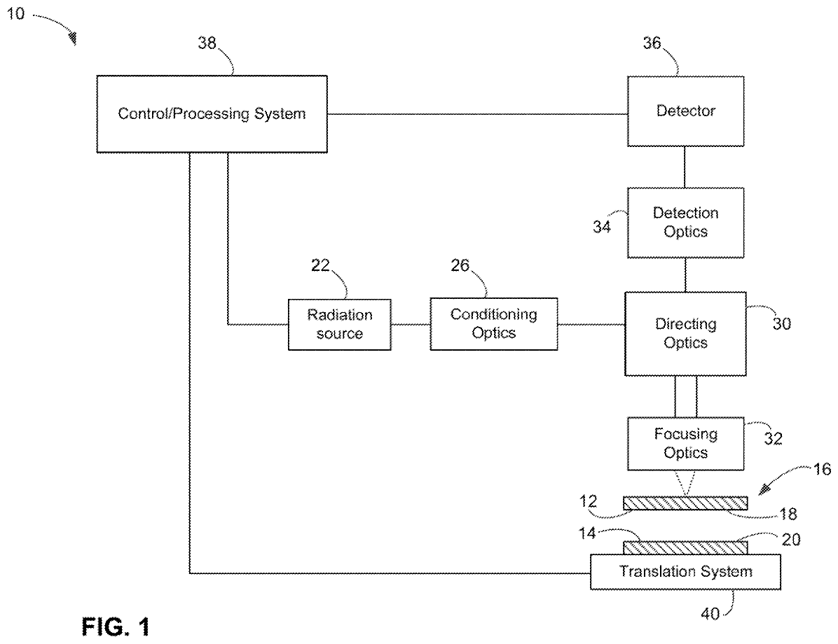

FIG. 1 illustrates an example imaging system 10. The imaging system 10 may be a production imaging system and/or a training imaging system (e.g., an imaging system used to train a machine learning model). The imaging system 10 may be capable of imaging one or more biological samples 12, 14 within a support structure 16. For example, in the illustrated embodiment, a first biological sample 12 may be present on a first surface 18 of the support structure 16 and/or a second biological sample 14 may be present on a second surface 20 of the support structure. The support structure 16 may, for example, be a flow cell. The support structure 16 may include an array of biological samples 12, 14 on one or more of the interior surfaces 18, 20. The interior surfaces may generally mutually face each other. Reagents, flushes, and/or other fluids may be introduced between the first and second surfaces. For example, fluids may be introduced for binding nucleotides and/or other molecules to the sites of biological samples 12, 14. The support structure 16 may be manufactured in conjunction with the present techniques or the support structure 16 may be purchased or otherwise obtained from a separate entity. Fluorescent tags on the molecules that bind to the samples may, for example, include dyes that fluoresce when excited by appropriate excitation radiation. In some embodiments, the support structure may be a multi-surface flow cell. In some examples, a fluid introduced to the support structure may only contact/be present for the second surface 20 of the support structure. For example, the fluid may be less than an entire channel depth (e.g., half of a flow cell channel depth).

Assay methods that include the use of fluorescent tags and that can be used in an apparatus or method set forth herein may include, for example, genotyping assays, gene expression analysis, methylation analysis, and/or nucleic acid sequencing analysis. Those skilled in the art will recognize that a flow cell or other support structure may be used with any of a variety of arrays known in the art to achieve similar results. Furthermore, known methods for making arrays can be used, and, for example, modified in accordance with the teaching set forth herein in order to create a flow cell and/or other support structure having multiple surfaces useful in the detection methods set forth herein. Arrays may be formed by disposing biological components of samples randomly and/or in predefined patterns on one or more surfaces of the support by any known technique. Different surfaces of the support structure may have different patterns of nanowells. In some embodiments, clustered arrays of nucleic acid colonies can be prepared as described in U.S. Pat. No. 7,115,400; U.S. Patent Application Publication No. 2005/0100900; PCT Publication No. WO 00/18957; or PCT Publication No. WO 98/44151, each of which is hereby incorporated by reference. Such methods are known as bridge amplification or solid-phase amplification and are particularly useful for sequencing applications.

Other random arrays, and methods for their construction, that may be used may include, without limitation, those in which beads are associated with a solid support, examples of which are described in U.S. Pat. Nos. 6,355,431; 6,327,410; and 6,770,441; U.S. Patent Application Publication Nos. 2004/0185483 and US 2002/0102578; and PCT Publication No. WO 00/63437, each of which is hereby incorporated by reference. Beads may be located at discrete locations, for example, wells, on a solid-phase support, whereby each location accommodates a single bead. Other structures, and methods for their construction, that may be used may include, without limitation, flow cell structures, examples of which are described in U.S. Pat. Nos. 9,512,422; and 10,682,829, each of which is hereby incorporated by reference.

Sites or features of an array may be discrete, for example, being separated with spaces between each other. The size of the sites and/or spacing between the sites may vary such that arrays may have sites that are separated by less than 100 micrometers (μm), 50 μm, 10 μm, 5 μm, 1 μm, 900 nanometer (nm), 800 nm, 700 nm, 600 nm, 500 nm, 400 nm, 350 nm, 300 nm, 250 nm, or 200 nm.

In some embodiments, a surface used in an apparatus or method may be a manufactured surface. It is also possible to use a natural surface or a surface of a natural support structure, however, the surface may not be a natural material or a surface of a natural support structure. Accordingly, components of biological samples may be removed from their native environment and attached to a manufactured surface.

Any of a variety of biological samples may be present on a surface. Example samples and/or components include, without limitation, nucleic acids such as, for example, DNA or RNA, proteins such as enzymes or receptors, polypeptides, nucleotides, amino acids, saccharides, cofactors, metabolites and/or derivatives of these natural samples. Although the apparatus and methods of the invention are exemplified herein with respect to components of biological samples, it will be understood that other samples or components can be used as well. For example, synthetic samples can be used such as combinatorial libraries, or libraries of compounds having species known or suspected of having a desired structure or function. Thus, the apparatus or methods can be used to synthesize a collection of compounds and/or screen a collection of compounds for a desired structure or function. The terms sample and component may be used interchangeably herein.

Returning to the exemplary system of FIG. 1, the imaging system 10 may include at least an excitation radiation source 22. The excitation radiation source 22 may be a laser source, electron beam source, one or more light emitting diodes, a plasma source, an arc lamp, a halogen lamp, or any other excitation radiation source. For example, the laser may operate at different wavelengths. The selection of the wavelengths for the laser may depend upon the fluorescence properties of the dyes used to image the component sites. Multiple different wavelengths of the laser used may permit differentiation of the dyes at the various sites within the support structure 16, and/or imaging may proceed by successive acquisition of a series of images to enable identification of the molecules at the component sites in accordance with image processing and reading logic. Other excitation radiation sources can be used including, for example, an electron beam source, a plasma source, an arc lamp, or quartz halogen lamp. In some embodiments, the excitation radiation source may produce electromagnetic radiation in the ultraviolet (UV) range (e.g., about 200 to 390 nm), visible (VIS) range (e.g., about 390 to 770 nm), infrared (IR) range (e.g., about 0.77 to 25 microns), or other range of the electromagnetic spectrum.

For ease of description, embodiments utilizing fluorescence-based detection are used as examples. However, other detection methods can be used in connection with the apparatus and methods set forth herein. For example, a variety of different emission types may be detected such as fluorescence, luminescence, or chemiluminescence. Accordingly, samples to be detected may be labeled with compounds or moieties that are fluorescent, luminescent, or chemiluminescent. Signals other than optical signals may also be detected from one or more surfaces using apparatus and methods that are analogous to those exemplified herein.

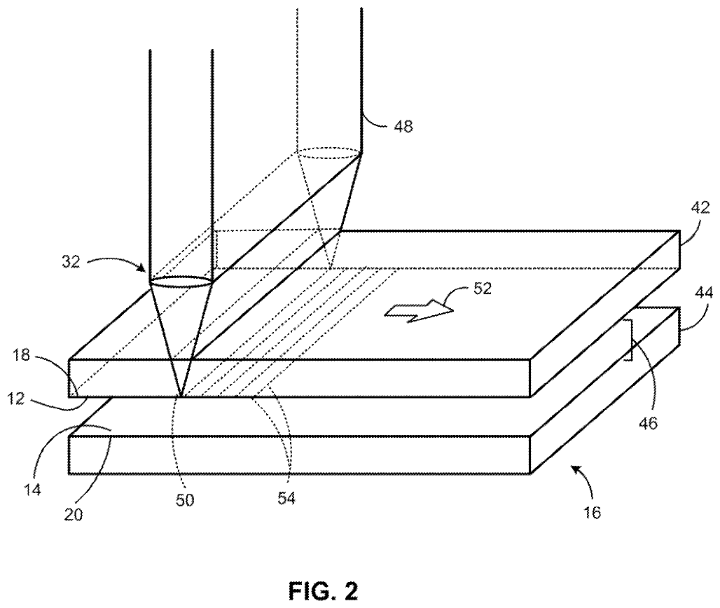

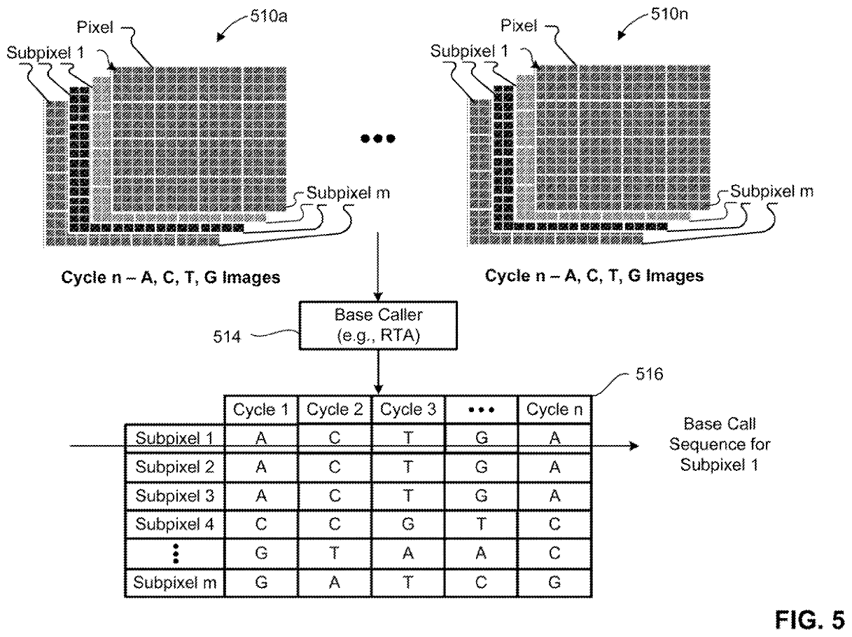

Output from the excitation radiation source 22 may be directed through conditioning optics 26 for filtering and shaping of one or more excitation beams. The conditioning optics may be included in the optical train in some embodiments. For example, in some embodiments, the conditioning optics 26 may generate a substantially linear beam of radiation, such as that shown and described in reference to FIG. 2, and/or combine excitation beams from multiple excitation radiation sources, for example, as described in U.S. Pat. No. 7,329,860. In other implementations, the conditioning optics 26 can form a rectilinear footprint, such as a rectangular or square footprint for the illumination, a circular footprint, an ovular footprint, or any other geometric configuration, such as described in reference to FIG. 4. The laser modules may include a measuring component that records the power of one or more lasers. The measurement of power may be used as a feedback mechanism. The feedback mechanism may be used to control the length of time an image is recorded in order to, for example, obtain uniform exposure, and therefore more readily comparable signals.

An excitation beam may be directed toward directing optics 30. The directing optics may be included in the optical train in some embodiments. For example, after passing through the conditioning optics 26, the one or more excitation beams may be directed toward directing, optics 30 which may redirect the one or more excitation beams. The directing optics 30 may be configured to redirect one or more beams from an excitation radiation source. For example, the one or more excitation beams may be directed from the excitation radiation source 22 toward focusing optics 32. The directing optics 30 may include a dichroic mirror configured to redirect the one or more excitation beams toward the focusing optics 32 and/or allowing certain wavelengths of a retrobeam to pass therethrough. The focusing optics 32 may confocally direct radiation to one or more surfaces 18, 20 of the support structure 16 upon which individual biological samples 12, 14 are located. For instance, the focusing optics 32 may include a microscope objective that confocally directs and concentrates the excitation radiation source 22 along a line to a surface 18, 20 of the support structure 16. In other implementations, the focusing optics 32 can form a rectilinear footprint, such as a rectangular or square footprint for illumination, a circular footprint, an ovular footprint, or any other geometric configuration at one or both of surface 18, 20. In some embodiments, the directing optics may be configured to redirect an excitation beam from an excitation radiation source toward the support structure.

The focusing optics 32 may be included in the optical train. The focusing optics 32 may be configured to focus radiation to a surface of the support structure. For example, the focusing optics 32 may be configured to confocally direct radiation to a surface of the support structure 16. In some embodiments, the focusing optics 32 may be configured for a single design point for diffraction-limited focusing and imaging. For example, the design point may be located at one or more of the first surface 18, the second surface 20, between the first surface 18 and the second surface 20 of the support structure 16, below the second surface 20, or above the first surface 18. In some embodiments, the focusing optics 32 may be defined by a numerical aperture (NA). For example, the numerical aperture may have a value of at least about 0.5, at least about 0.55, at least about 0.6, at least about 0.65, at least about 0.7, at least about 0.75, at least about 0.8, at least about 0.85, at least about 0.9, at least about 0.95, above about 1.0, above about 1.1, above about 1.2, or above about 1.3.

The biological samples may include emissive components. For example, a first emissive component associated with a biological sample may be disposed on the first surface 18 of the support structure 16 and/or a second emissive component associated with a biological sample may be disposed on the second surface 20 of the support structure 16. The first emissive component or second emissive component associated with the biological sample sites on the support structure 16 may fluoresce at particular wavelengths in response to an excitation beam and thereby return radiation for imaging. For example, the fluorescent components may be generated by fluorescently tagged nucleic acids that hybridize to complementary molecules of the components or to fluorescently tagged nucleotides that are incorporated into an oligonucleotide using a polymerase. As noted above, the fluorescent properties of these components may be changed through the introduction of reagents into the support structure 16 (e.g., by cleaving the dye from the molecule, blocking attachment of additional molecules, adding a quenching reagent, adding an acceptor of energy transfer, and so forth). The wavelength at which the dyes of the sample are excited and/or the wavelength at which the dyes of the sample fluoresce may depend upon the absorption and/or emission spectra of the specific dyes. Returned radiation may propagate back through the directing optics 30. This retrobeam may be directed toward the detection optics 34. For example, the detection optics 34 may filter the beam such as to separate different wavelengths within the retrobeam, and/or direct the retrobeam toward at least one detector 36. For example, two or more detectors as described herein may be provided. In some embodiments, there may be one detector for each specific wavelength and/or wavelength range. Additionally, or alternatively, there may be one excitation radiation source for each specific wavelength and/or wavelength range.

In some embodiments, the detection optics 34 may be configured to detect radiation emissions. The radiation emissions may be returned to the detection optics 34 from one or more of the emissive component and/or the second emissive component. In some embodiments, the first emissive component may include a first nanowell pattern and/or the second emissive component may include a second nanowell pattern. The first nanowell pattern may be different from the second nanowell pattern or may be the same nanowell pattern. The radiation emissions may be returned to the detection optics 34, for example, via the optical train.

The detector 36 may be based upon any suitable technology, and may be, for example, a charged coupled device (CCD) sensor. The detector may generate pixilated image data based upon photons impacting one or more locations in the detector. However, any of a variety of other detectors may also be used including, but not limited to, a detector array configured for time delay integration (TDI) operation, a complementary metal oxide semiconductor (CMOS) detector, an avalanche photodiode (APD) detector, a Geiger-mode photon counter, or any other suitable detector TDI mode detection can be coupled with line scanning as described in U.S. Pat. No. 7,329,860, which is incorporated by reference herein.

The detector 36 may generate image data. In some examples, the image data may be at a resolution between 0.1 and 50 microns. The image data may be forwarded to a control/processing system 38. The control/processing system 38 may perform various operations, such as, for example, analog-to-digital conversion, scaling, filtering, and/or association of the data in multiple frames to appropriately and accurately image multiple sites at specific locations on a sample. The control/processing system 38 may store the image data and/or may forward the image data to a post-processing system (not shown) where, for example, the data is analyzed. Depending upon the types of samples, the reagents used, and/or the processing performed, a number of different uses may be made of the image data. For example, nucleotide sequence data can be derived from the image data, and/or the data may be employed to determine the presence of a particular gene, characterize one or more molecules at the component sites, and so forth. As described in more detail herein, a system (e.g., server) may use an aberration compensation model (e.g., algorithm) that is configured to compensate for aberrations (e.g., spherical aberrations) of the image data received from an imaging system, such as from the control/processing system 38 (e.g., such as spherical aberrations of the image data taken of emissive component located on two different surfaces of a support structure, such as a flow cell). Further, as noted herein, the imaging system may not include a corrective compensator component.

The operation of the various elements illustrated in FIG. 1 may also be coordinated with the control/processing system 38. For example, the control/processing system 38 may include hardware, firmware, and/or software designed. The hardware, firmware, and/or software may control one or more of operation of the excitation radiation source(s) 22, movement and focusing of the focusing optics 32, a translation system 40, and the detection optics 34, and acquisition and processing of signals from the detector 36. The control/processing system 38 may store processed data and/or further process the data. For example, data may be used for generating a reconstructed image of irradiated sites that fluoresce within the support structure 16. The image data may be analyzed by the system, and/or may be stored for analysis by other systems and/or at different times subsequent to imaging.

Image data may include one or more of first image data of the first emissive component based on detected radiation emissions and second image data of the second emissive component based on detected radiation emissions. In some embodiments, the detector may be configured to generate image data of the first emissive component when the focusing optics confocally directs radiation to the first emissive component, and/or generate image data of the second emissive component when the focusing optics confocally directs radiation to the second emissive component.

The support structure 16 may be supported on a translation system 40. The translation system 40 may allow for focusing and/or movement of the support structure 16 before and/or during imaging. The stage may be configured to move the support structure 16, thereby changing the relative positions of the excitation radiation source 22 and detector 36 with respect to the surface bound biological samples for progressive scanning. Movement of the translation system 40 may be in one or more dimensions including, for example, one or both of the dimensions that are orthogonal to the direction of propagation for the excitation radiation, typically denoted as the X and Y dimensions. In some embodiments, the translation system 40 may be configured to move in a direction perpendicular to the scan axis for a detector array. The translation system 40 may be further configured for movement in the dimension along which the excitation radiation line propagates, typically denoted as the Z dimension. Movement in the Z dimension can also be useful for focusing. In some examples, multiple detectors may be provided. In other implementations, the support structure 16 can remain stationary and the directing optics 30 and/or focusing optics 32 can be translated orthogonally to the direction of propagation for the excitation radiation.

FIG. 2 is a diagram of an example semi-confocal line scanning approach to imaging the support structure 16. In the illustrated embodiment, the support structure 16 may include an upper substrate 42 and/or a lower substrate 44. An internal volume 46 may be provided between the upper and lower substrates 42, 44. The upper and lower substrates 42, 44 may be made of any of a variety of materials, for example, a substrate material that is substantially transparent at the wavelengths of the excitation radiation and the fluoresced retrobeam, allowing for the passage of excitation radiation and returned fluorescent emissions without significant loss of signal quality. One of the surfaces through which the radiation traverses may be substantially transparent at the relevant wavelengths, while the other (which is not traversed by radiation) may be less transparent, translucent, or even opaque or reflective. The upper and lower substrates 42, 44 may both contain biological samples 12, 14 on their respective, inwardly facing surfaces 18, 20. As discussed herein, the internal volume 46 may, for example, include one or more internal passages of a flow cell though which reagent fluids may flow.

The support structure 16 may be irradiated by excitation radiation 48 along a radiation line 50. The radiation line 50 may be formed by the excitation radiation 48 from the excitation radiation source 22, and/or directed by the directing optics 30, for example, through the focusing optics 32. The radiation may be directed towards one or more of the first and second emissive components. In some examples, the radiation line 50 may be configured to reside between the first and second emissive components. The excitation radiation source 22 may generate one or more excitation beams or more than one excitation radiation source 22 may be used and each may generate a corresponding excitation beam. The one or more excitation beams may be processed and/or shaped to provide a linear cross section, a rectangular cross section, or any other geometric cross section and each radiation line can be a particular wavelength of radiation used to cause fluorescence at a corresponding wavelength from a dye associated with the biological samples 12, 14, depending upon the particular dyes used. The focusing optics 32 may semi-confocally direct the excitation radiation 48 toward the first surface 18 of the support structure 16 to irradiate dyes associated with sites of biological sample 12 along the radiation line 50. In some embodiments, one or more of the support structures 16, the directing optics 30, the focusing optics 32, or some combination thereof, may be translated such that the resulting radiation line 50 progressively irradiates the component as indicated by the arrow 52. Translation may result in successive scanning of regions 54. Scanning may allow for the gradual irradiation of the entire first surface 18 of the support structure 16. As will be discussed in more detail below, the same process may also be used to gradually irradiate the second surface 20 of the support structure 16. For example, the process may be used for multiple surfaces within the support structure 16.

Exemplary methods and apparatus for line scanning are described in U.S. Pat. No. 7,329,860, which is incorporated herein by reference, and which describes a line scanning apparatus having a detector array configured to achieve confocality in the scanning axis by restricting the scan-axis dimension of the detector array. More specifically, the scanning apparatus may be configured such that the detector array has rectangular dimensions such that the shorter dimension of the detector is in the scan-axis dimension and imaging optics are placed to direct a rectangular image of a sample region to the detector array such that the shorter dimension of the image is also in the scan-axis dimension. In some embodiments, semi-confocality can be achieved since confocality occurs in a single axis (e.g., the scan axis). For example, detection may be specific for features on the surface of a substrate, thereby rejecting signals that may arise from the solution around the feature. The apparatus and methods described in U.S. Pat. No. 7,329,860 may be modified such that two or more surfaces of a support are scanned in accordance with the description herein. The optical train may include the imaging optics. The imaging optics may be configured to focus the optical train towards the support structure, for example.

Detection apparatus and methods other than line scanning may also be used. For example, point scanning may be used as described in U.S. Pat. No. 5,646,411, which is incorporated herein by reference. In some embodiments, wide angle area detection may be used with or without scanning motion.

As illustrated generally in FIG. 2, the radiation line 50 used to illuminate fluorescent dyes to be imaged that are associated with the sites of biological samples 12, 14, may be a continuous or discontinuous line. As such, some embodiments may include a discontinuous line made up of a plurality of confocally and/or semi-confocally directed excitation beams of radiation which may irradiate a plurality of points along the radiation line 50 Discontinuous excitation beams may be created by one or more sources that may be positioned or scanned to provide the excitation radiation 48. The excitation beams, may be confocally or semi-confocally directed toward the first or second surfaces 18, 20 of the support structure 16 to irradiate sites of biological samples 12, 14. As with the continuous semi-confocal line scanning described herein, the support structure 16, the directing optics 30, the focusing optics 32, or some combination thereof, may be advanced as indicated by arrow 52 to irradiate successive scanned regions 54 along the first or second surfaces 18, 20 of the support structure 16, and thereby successive regions of the sites of biological samples 12, 14.

In some embodiments, the system 10 may form and direct excitation and returned radiation simultaneously for imaging. For example, confocal scanning may be used such that the optical system directs an excitation pattern across a biological sample by scanning the excitation beam through an objective lens. The detector may image the emission from the excited region on the detector, for example, without “de-scanning” the retrobeam. This may occur since the retrobeam may be collected by the objective lens and/or is split off the excitation beam optical path before returning back through the scan means The image of the excitation pattern at the detector 36 may appear in the shape of a line as the excitation pattern is scanned across the sample. The retrobeam of radiation may be at a different wavelength from the excitation beam. Alternatively, or additionally, emission signals may be collected sequentially following sequential excitation at different wavelengths.

In some embodiments, the system 10 may detect features on a surface at a rate of at least about 0.01 mm/sec. Faster rates may also be used including, for example, in terms of the area scanned or otherwise detected, a rate of at least about 0.02 mm²/sec, 0.05 mm²/sec, 0.1 mm²/sec, 1 mm²/sec, 1.5 mm²/sec, 5 mm²/sec, 10 mm²/sec, 50 mm²/sec, 100 mm²/sec, or faster. If desired, for example, to reduce noise, the detection rate may have an upper limit of about 0.05 mm²/sec, 0.1 mm²/sec, 1 mm²/sec, 1.5 mm²/sec, 5 mm²/sec, 10 mm²/sec, 50 mm²/sec, or 100 mm²/sec.

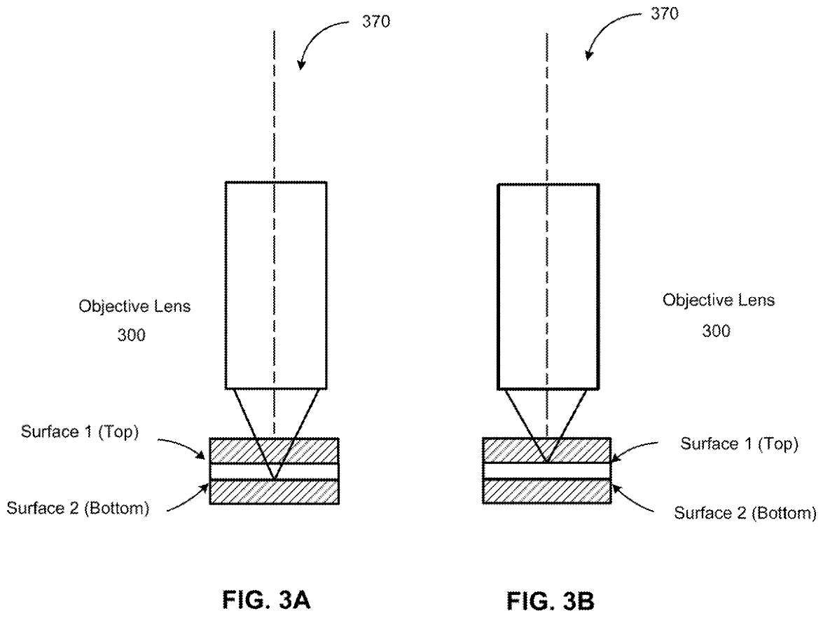

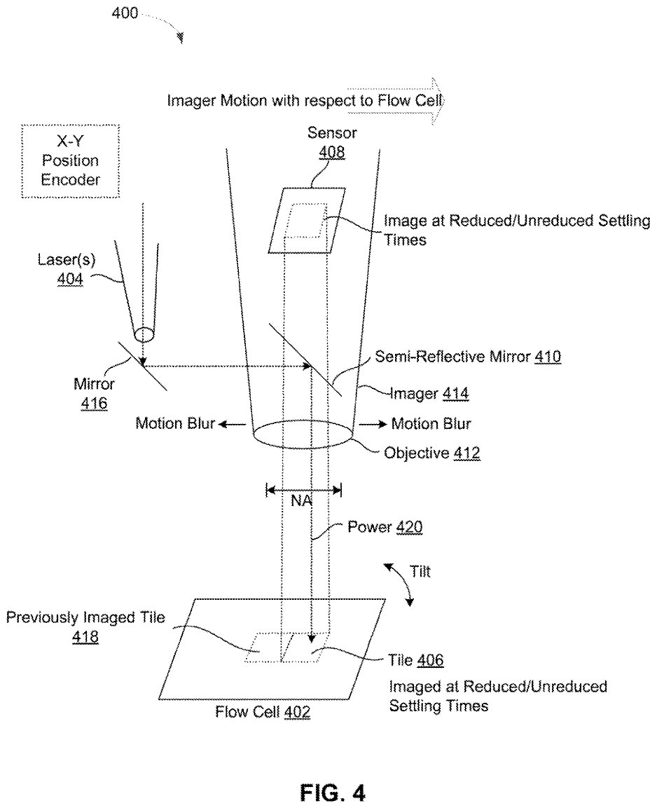

FIG. 3A illustrates an example objective lens 300 that is focused on a bottom surface (surface 2) of a support structure (e.g., a flow cell), and FIG. 3B illustrates the example objective lens 300 that is focused on an upper surface (surface 1) of the support structure (e.g., a flow cell). The objective lens 300 may focus and detect images from the bottom surface of the flow (e.g., as shown in FIG. 3A) or the upper surface (e.g., as shown in FIG. 3B). Positioning one or more of the optical train, flow cell, and excitation radiation source, may shift the focus of objective lens 300 to the top surface or the bottom surface. For example, an optical component may be inserted into and/or removed from the optical train to compensate for focusing between the top and bottom surfaces. Alternatively, or additionally, an optical component within a tube lens may be moved to compensate for focusing between the top and bottom surfaces, such as that described in U.S. Pat. Pub. No. 2018/0259768, entitled “Continuous spherical aberration correction tube lens,” published Sep. 13, 2018, the disclosure of which is hereby incorporated in its entirety. An excitation beam 370 may be focused and/or delivered to any location of the support structure. For example, the excitation beam 370 may be focused and/or delivered to one or more of a location between the top surface (or surface 1) and the bottom surface (or surface 2), a location on the top surface (or surface 1), a location on the bottom surface (or surface 2), a location above the top surface (or surface 1), or a location below the bottom surface (or surface 2). Additionally, or alternatively, the excitation beam 370 may be focused and/or delivered to one or more of a location within the upper substrate and/or within the lower substrate (e.g., as shown in FIG. 2.

FIG. 4 illustrates an example of an imaging system 400 for imaging support structures (e.g., flow cells), such as a flow cell 402 as well as example opportunities for flow cell image improvement, enhancement, refinement, and/or other operations such as to enable improved base calling during sequencing by synthesis. The flow cell 402 may be generally planar and/or comprise a plurality of generally parallel lanes imaged sequentially (e.g., point-and-shoot as shown in the present FIG. 4) as a series of tiles or as one or more columns imaged continuously (e.g., continuous line scanning as shown in FIG. 2) and processed as a series of one or more tiles 406. The imager 414 may comprise one or more of a sensor 408, a semi-reflective mirror 410, and an objective 412. In some examples, one or more excitation radiation sources (e.g., lasers 404 or LEDs) and the imager 414, as well as a mirror 416 positioned to direct emissions of the lasers 404 toward the semi-reflective mirror 410, may be arranged in a module.

The example opportunities arise as an imager 414 is repositioned from one tile the next (e.g., ‘step’ of step-and-shoot) and then one or more lasers 404 illuminate a tile 406 of the flow cell 402 to stimulate fluorescence that is then imaged by a sensor 408 of an imager 414 (e.g., ‘shoot’ of step-and-shoot) or as the flow cell 402 and/or imager 414 is moved along one or more columns (e.g., continuous line scanning) and the stimulated fluorescence is imaged by the sensor 408 of the imager 414. Improved flow cell imaging includes, for example, flow cell image improvement, enhancement, refinement, and/or other operations such as to enable improved base calling during sequencing by synthesis.

In some embodiments, the imager 414 and the flow cell 402 are moved relative to each other (e.g., such as by the flow cell 402 proceeding on a movable platform along a predetermined path or by the imager 414 and the lasers 404 repositioning with respect to the flow cell 402 as images are taken), as indicated by arrow Imager Motion with respect to Flow Cell. In point-and-shoot implementations, for example, the Previously Imaged Tile 418 and the Tile 406 (e.g., Imaged at Reduced/Unreduced Settling Time) may represent two contiguous elements of the series of tiles, one imaged after the other. In continuous scanning implementations, the Previously Imaged Tile 418 and the Tile 406 (e.g., Imaged at Reduced/Unreduced Settling Time) may represent two contiguous regions of a portion of a lane of a flow cell 402 (or alternatively a column thereof) that correspond to elements of the series of tiles.

In some embodiments, the movable platform (e.g., sometimes referred to as a stage) comprises a flow cell receiving surface enabled to support the flow cell 402. For example, a controller is coupled to the stage and the optical assembly. Some implementations of the controller are configured to move the stage and the optical assembly relative to each other in a step-and-shoot manner, sometimes referred to as a step and settle technique. Some implementations of the controller are configured to image a tiled region prior to settling of the relative movement of the stage and the optical assembly. Some implementations of the controller are configured to image a tiled region after settling of the relative movement of the stage and the optical assembly. In some embodiments, a biological sequencing instrument (e.g., such as a laboratory instrument or a production instrument) may comprise all or any portions of elements depicted in the figure. In some examples, the biological sequencing instrument comprises the stage, the optical assembly, and/or the controller.

In operation, the imager 414 may be moved with respect the flow cell 402 as indicated by the wide arrow (e.g., Imager Motion with respect to Flow Cell), thus repositioning the imager 414 from alignment with the first tile (e.g., Previously Imaged Tile 418) to alignment with the second tile (e.g., Tile 406 Imaged at Reduced/Unreduced Settling Times). Imaging may proceed by operating the one or more lasers 404. Emission of the one or more lasers 404 or LEDs may be reflected off a mirror 416 onto a semi-reflective mirror 410 and/or reflected off the semi-reflective mirror 410 to illuminate the tile 406 of the flow cell 402, as illustrated, for example, by a dashed arrow (e.g., Power 420) directed to the second tile (e.g., Tile 406 Imaged at Reduced/Unreduced Settling Times). Responsive to the illumination, fluorophores associated with a sample located at the tile 402 may fluoresce. Light from the fluorescing may pass through the objective 412 for focusing and/or continue through the semi-reflective mirror 410 forming an image (e.g., Tile 406 Imaged at Reduced/Unreduced Settling Times). The image may be captured by a sensor (e.g., Sensor 408).

In some embodiments, a full movement settling time delay may transpire before capturing an image (e.g., an “Unreduced” movement settling time, corresponding to an unreduced movement settling time image). In some examples, less than a full movement settling time delay may transpire before capturing an image (e.g., a “Reduced” movement settling time, corresponding to a reduced movement settling time image). Images captured before the full movement settling time delay transpires may be captured while there is relative movement between the imager 414 and the tile 406. Therefore, the images may be subject to aberrations, such as motion blur, and/or appear degraded with respect to images captured after the full movement settling time delay transpires. In some embodiments, capturing reduced movement settling time images (e.g., conceptually represented as instances of “Motion Blur” in the figure) may be one of the example opportunities for improved flow cell imaging.

Other instances of the example opportunities for improved cell imaging may include one or more of reduced excitation power, tilt and/or non-planar blur, and a reduced numerical aperture of the imager 414.

The reduced excitation power (e.g., conceptually illustrated by “Power” 420 in the figure), for example, may be introduced by fluorescence-inducing illumination using one or more lasers or LEDs operating at a reduced excitation power. The reduced excitation power may result, for example, in images that are degraded with respect to images taken using unreduced excitation power.

The tilt and/or non-planar blur (e.g., conceptually illustrated by “Tilt” in the figure), for example, may be introduced by differences in distance between the imager 414 and various areas of a tile being imaged. For example, a nominally planar flow cell may be out of optical alignment (e.g., tilted) with respect to the imager 414 so that different portions (e.g., or more edges) of a same tile are at different distances from the imager 414. In some embodiments, dependent on depth of field of the imager 414, one of the portions is improperly focused and thus degraded, for example, cause aberrations on the resulting image. In some examples, an otherwise nominally planar flow cell may have an imperfection so that one portion of a tile 406 is closer to the imager 414 than another portion of the tile 406.

The reduced numerical aperture of the imager 414 (e.g., conceptually illustrated by “NA” in the figure), for example, may be introduced by using an imager 414 of a lower numerical aperture compared to an imager 414 of a larger numerical aperture. The lower numerical aperture may result in images that are degraded with respect to images taken with the imager 414 of the larger numerical aperture. The reduced numerical aperture (e.g., NA) may be equal to n sin(theta), where n is index of refraction and theta is the half-angle of the cone of light that the system (e.g., optics) can detect.

In some embodiments, an X-Y Position Encoder may be included. The X-Y Position Encoder may measure an x-y position in real-time of the imager 414 with respect to the flow cell 402 and/or tile 406 therein. In some examples, the x-y position measurements may be referred to as x-y stage positions of images and/or x-y stage positions. Results of the measurements may be usable during a pre-run check of an instrument. In some embodiments, results of the measurements may be usable to provide an estimate of expected amount of motion blur in an image. For example, there may be differences in motion blur responsive to the imager 414 being located near an edge of a flow cell versus being located near the center of the flow cell. Information from the measurements may enable processing dependent on the differences. In some embodiments, information from the measurements may be provided to training and/or production contexts, such, for example, as via metadata included in training and/or production images.

In some embodiments, during the training described herein, information from an X-Y Position Encoder may be used along with training image data to learn parameters of the training context. During the production described, for example, information from the X-Y Position Encoder may be used along with production image data to produce enhanced images.

In some embodiments, generalizing AI-based denoising to new noise profiles may be challenging (e.g., an AI-model trained to remove Gaussian white noise with σ=x performs worse when σ=y). In some examples, using information from an X-Y Position Encoder during training and/or production of an AI model (e.g., such as any of the NN portions described elsewhere herein) conceptually may act to feed knowledge about an expected noise source into the AI model during the training and/or the production, thus enabling improved AI-based denoising performance.

As noted herein, the system may be configured to capture images of emissive components located on multiple surfaces of a support structure (e.g., a flow cell). The images may be of the emissive component and may be based on the radiation emissions by the biological sample. The radiation may be at a different wavelengths (e.g., based on the corresponding nucleotide channels A, C, G and T). For example, at the end of each sequencing cycle, the control/processing system may receive a set of one or more (e.g., four) images in the optimal wavelengths that was generated by the detector for each of the fluorophores to detect the emitted fluorescence. In other examples, the control/processing system may receive a set of one or more (e.g., two images). Each image may be received via a channel. For example, a first image may be received via a first channel and/or a second image may be received via a second channel. The first channel and/or the second channel may be used to code (e.g., binary code) one or more of the nucleotide bases A, C, G and T.

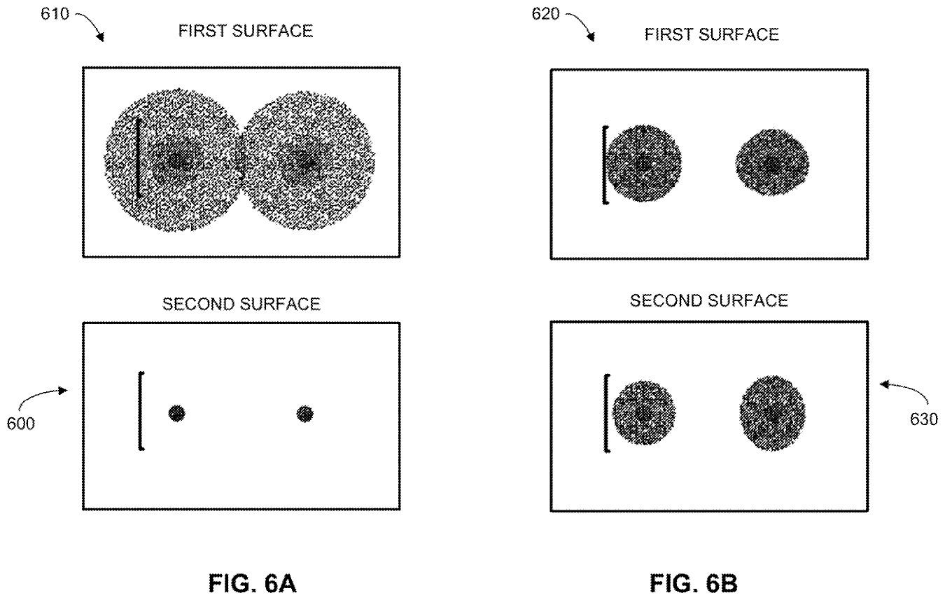

FIG. 5 depicts an example of base calling. A system (e.g., a server device(s) may include a base call algorithm that is configured to perform a base call on biological samples that are being sequenced. FIG. 5 depicts an example of subpixel base calling, of which the invention is not so limited. In FIG. 5, each sequencing cycle 510a-510n has an image set with four distinct images (e.g., A, C, T, G images) captured using four different wavelength bands (e.g., image/imaging channel) and four different fluorescent dyes (e.g., one for each base). It should be appreciated that the system described herein may be a one channel, two channel, or four channel system.

The pixels in the images may be divided into a plurality of subpixels, such as sixteen subpixels as illustrated in FIG. 5. The subpixels may then separately base called at each sequencing cycle by the base caller 514. To base call a given subpixel at a particular sequencing cycle, the base caller 514 may use intensities of the given subpixel in each of the four A, C, T, G images. For example, intensities in image regions covered by subpixel 1 in each of the four A, C, T, G images of cycle 1 may be used to base call subpixel 1 at cycle 1. For subpixel 1, these image regions include top-left one-sixteenth area of the respective top-left pixels in each of the four A, C, T, G images of cycle 1. Similarly, intensities in image regions covered by subpixel m in each of the four A, C, T, G images of cycle n may be used to base call subpixel m at cycle n. For subpixel m, these image regions may include bottom-right one-sixteenth area of the respective bottom-right pixels in each of the four A, C, T, G images of cycle 1. In some embodiments, this process may produce subpixel-wise base call sequences 516 across the plurality of sequencing cycles.

However, as noted above, the images may include aberrations (e.g., spherical aberrations, sometimes referred to as blur). Spherical aberrations may be a type of aberration found in optical systems (e.g., the lends of the focusing optics 32) that have elements with spherical surfaces. Radiation (e.g., light rays) may strike the lens of the optical system off-center, and may be refracted or reflected more or less than those that strike close to the center of the lens, which may cause the resulting image to include a spherical aberration that reduces the quality of images. As described herein, the presence of aberrations, and specifically spherical aberrations, can prevent the system from successfully base callings a sample.

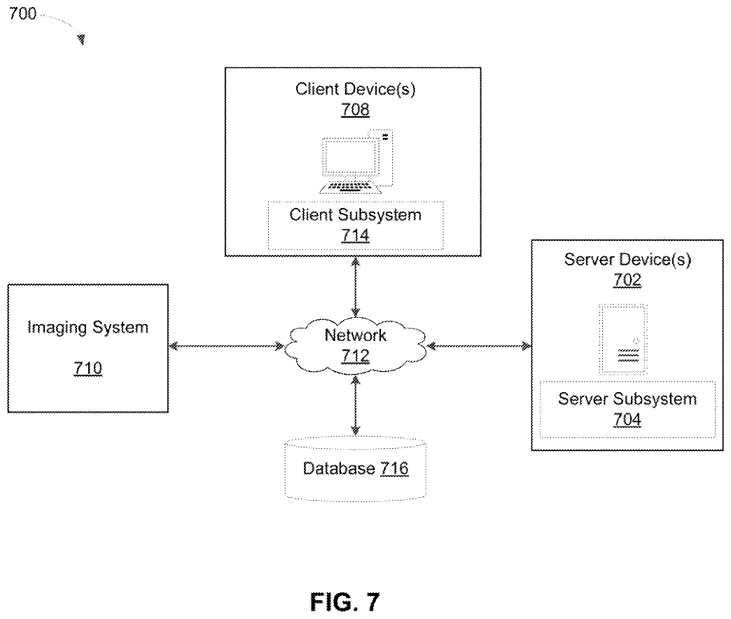

FIG. 6A and FIG. 6B illustrate examples of images taken of two surfaces of a support structure, where the images have spherical aberrations. In FIG. 6A, a lens of the system may be focused on the second surface, such that the image 600 of the second surface has little or no spherical aberrations (e.g., the design point of the objective may be on the second surfaces), while the image 610 of the first surface has significant spherical aberrations. There may be aberration compensation as described herein for the second surface and/or there may be no aberration compensation for the first surface (e.g., resulting in spherical aberrations). In FIG. 6B, the lens of the system may be focused on an area between the first surface and the second surface (e.g., the design point of the objective may be between the first and second surfaces), such that the image 620 of the first surface and the image 630 of the second surface both experience a similar level of spherical aberration. There may be aberration compensation (e.g., average aberration compensation) as described herein for one or more of (e.g., both) the first surface and the second surface.

The system (e.g., a server that receives images from an imaging system, such as the imaging system 10 of FIG. 1) may be unable to accurately base call images that have a spherical aberration outside of a particular range. As such, the systems described herein may be configured to determine base calls from images that have spherical aberrations using an aberration compensation model. For example, the system may be configured to generate first image data of a first emissive component that resides on a first surface of the support structure (e.g., the first biological sample 12 present on the first surface 18 of the support structure 16), and a second image data of a second emissive component that resides on a second surface of the support structure (e.g., the second biological sample 14 present on the second surface 20 of the support structure 16). One or more of the first image data and the second image data may include an intensity for an irradiated site.

The first and second image data may include spherical aberrations, for example, for the reasons noted herein. The system may be configured to perform base calls of the biological samples that are located on multiple surfaces of a support structure using the image data, and as noted herein, an aberration compensation model. For example, the system may generate one or more reconstructed images of the images of the plurality of surfaces of the support structure using the aberration compensation model, and then determine the base calls using the reconstructed images. Alternatively, the system may be configured to determine a base call directly from one or more of the first image data and the second image data (e.g., which include spherical aberrations) using the aberration compensation model (e.g., and without generating reconstructed images prior to base calling).

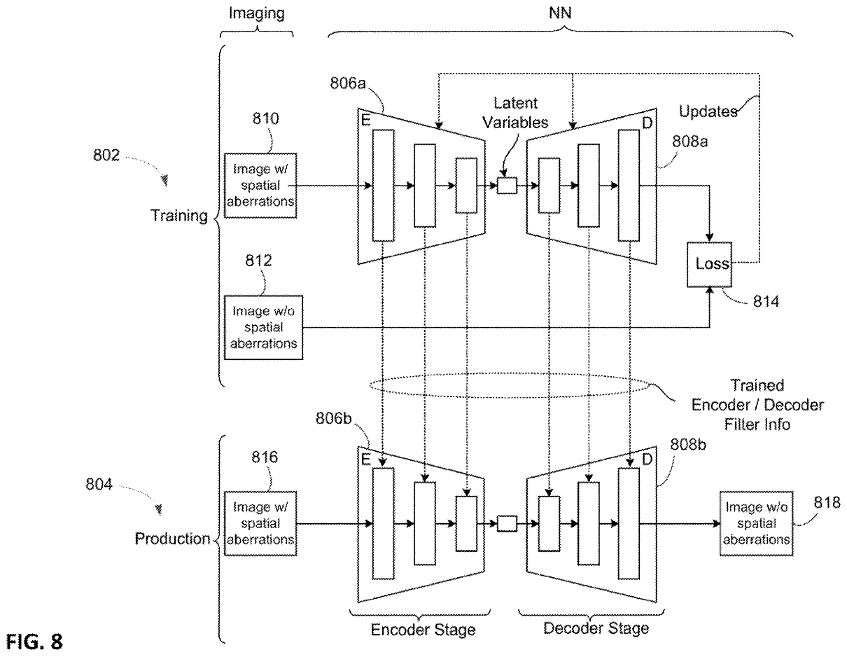

FIG. 7 illustrates a schematic diagram of a system 700. The system 700 may include one or more server device(s) 702 connected to one or more imaging systems 710. The imaging system 710 may be an imaging system of a sequencing device. For example, the imaging system 710 may be an example of the imaging system 10 comprising a control/processing system 38 of FIG. 1. The one or more server devices 702 may be connected to the one or more imaging systems or sequencing devices and/or client device(s) 708 via a network 712.

The server device(s) 702 and imaging systems 710 may communicate with each other via the network 712. For instance, the server device(s) 702 may receive image data from the imaging systems 710. The server device(s) 702 may also communicate with the client device(s) 708. In some examples, the server device(s) 702 may send data to the client device(s) 708, including sequencing data or other information and the server device(s) may receive input from users via client device(s) 708. The network 712 may comprise any suitable network over which computing devices and/or controllers of an imaging system can communicate. The network 712 may include a wired and/or wireless communication network. Example wireless communication networks may be comprised of one or more types of radio frequency (RF) communication signals using one or more wireless communication protocols, such as a cellular communication protocol, a wireless local area network (WLAN) or WIFI communication protocol, and/or another wireless communication protocol. In addition, or in the alternative to communicating across the network 712, the server device(s) 702, the imaging system(s) 710, and/or the client devices 708 may bypass the network 712 and may communicate directly with one another.

As further illustrated in FIG. 7, the system 700 may include a database 716. The database 716 can store information for being accessed by the devices in the system 700. The server device(s) 702 and the imaging system(s) 710 may communicate with the database 716 (e.g., directly or via the network 712) to store and/or access information.

The imaging system 710 may be part of a sequencing device and/or may comprise a device for imaging a biological sample. The imaging system 710 may be a production imaging system or a training imaging system (e.g., an imaging system used (e.g., only used) to train one or more predictive models). The system may include one more training imaging systems and/or one or more production imaging systems. The biological sample imaged by the imaging system 710 may include human and/or non-human deoxyribonucleic acid (DNA) to determine individual nucleotide bases of nucleic-acid sequences (e.g., sequencing by synthesis). The biological sample may include human and/or non-human ribonucleic acid (RNA). Example samples and/or components include, without limitation, nucleic acids such as, for example, DNA or RNA, proteins such as enzymes or receptors, polypeptides, nucleotides, amino acids, saccharides, cofactors, metabolites and/or derivatives of these natural samples. Although the apparatus and methods of the invention are exemplified herein with respect to components of biological samples, it will be understood that other samples or components can be used as well. For example, synthetic samples can be used such as combinatorial libraries, or libraries of compounds having species known or suspected of having a desired structure or function.

An example of image collection may include using an imager to simultaneously detect light emitted by a plurality of fluorescence-tagged nucleotides as the nucleotides are fluorescing responsive to excitation energy (such as laser excitation energy) as a collected image. The image may have one or more dimensions (e.g., a line of pixels or a two-dimensional array of pixels). The pixels may be represented according to one or more values. For example, each pixel may be represented by a single integer (e.g., such as an 8-bit integer) that represents intensity of the pixel (e.g., such as a greyscale). In another example, each pixel may be represented by a plurality of integers (e.g., such as three 24-bit integers) and each of the integers may represent intensity of the pixel according to a respective band of wavelengths (e.g., such as respective colors).

When implemented as a training imaging system, the imaging system 710 may be configured to produce images with aberrations that are used as training data. The imaging system 710 may be configured to produce images without aberrations that may be used for training an aberration compensation model based on the training images with aberrations. The images with aberrations and the images without aberrations may be images that were captured of the same sample, the same cycle, and/or with a majority of the field of views overlapping between the images (e.g., the images with aberrations and the images without aberrations).

In some examples, the images with aberrations may be captured without a spherical aberration compensator. The images without aberrations may be captured using the spherical aberration compensator. An image with aberrations and an image without aberrations may be aligned, for example using one or more fiducials. The one or more fiducials may be embedded on the support surface (e.g., flow cell).

Alternatively, or additionally, the images without aberrations may be captured when the imaging system 710 is in focus (e.g., the flow cell is in focus). The images with aberrations may be captured when the imaging system is out of focus (e.g., the flow cell is out of focus). The imaging system may be moved into and/or out of focus, for example, using the translation system. The translation system may include one or more motors. The imaging system may be moved into and/or out of focus by a predetermined distance, for example a predetermined number of nanometers.

Alternatively, or additionally, the images without aberrations and/or the images with aberrations may be captured by generating simulated images. For example, one or more models as herein may be used to generate the images without aberrations and/or the images with aberrations.

The server device(s) 702 may generate, receive, analyze, store, and/or transmit digital data (e.g., such as imaging data received from the training imaging system). As shown in FIG. 7, the imaging system 710 may generate and/or send imaging data to the server device(s) 702. The server device(s) 702 may comprise a distributed collection of servers where the server device(s) 702 may include a number of server devices distributed across the network 712 and/or located in the same and/or different physical locations. Further, the server device(s) 702 may comprise a content server, an application server, a communication server, a web-hosting server, and/or another type of server.

The server device(s) 702 may include a server subsystem 704. The server subsystem 704 may include software and/or hardware utilized by the server device(s) 702 for processing sequencing requests and/or data, as described herein. The server subsystem 704 may be included in a single server device 702 or may be distributed across multiple server devices 702. The server subsystem 704 may include a sequencing system that spans multiple layers of software and/or hardware for servicing requests for sequencing services at the server subsystem 704.

The server subsystem 704 may include Artificial Intelligence (AI) or Machine Learning (ML) that may be trained and/or implemented for analyzing image data for AI-driven signal enhancement of sequencing images (e.g., using a spherical aberration compensation model). An example may include AI-driven signal enhancement of sequencing images for base calling (e.g., of sequencing-by-synthesis (SBS)). The AI-driven signal enhancement may be implemented at least in part, for example, based on one or more machine learning techniques such as deep learning using one or more Neural Networks (NNs). Various examples of NNs include Fully-Connected NNs. Various examples of NNs include Convolutional Neural Networks (CNNs) generally (e.g., any NN having one or more layers performing convolution), as well as NNs having elements that include one or more CNNs and/or CNN-related elements (e.g., one or more convolutional layers), such as various implementations of Generative Adversarial Networks (GANs) generally, as well as various implementations of Conditional Generative Adversarial Networks (CGANs), cycle-consistent Generative Adversarial Networks (CycleGANs), and/or autoencoders. The various examples of NNs further include Recurrent Neural Networks (RNNs) generally (e.g., any NN in which output from a previous step is provided as input to a current step and/or having hidden state), as well as NNs having one or more elements related to recurrence. The various examples of NNs further include Multi-Layer Perceptron (MLP) neural networks. In some implementations, a GAN is implemented at least in part via one or more MLP elements. Additionally or alternatively, the aberration compensation model may include decoding, deep learning, deep Fourier channel attention network (DFCAN), optical transfer function (OTF) inversion, point spread function (PSF), iterative deconvolution, linear deconvolution, or nonlinear deconvolution (e.g., Lucy-Richardson).

Example implementations of a NN architecture may include various collections of software and/or hardware elements that collectively perform operations according to the NN architecture. Various NN implementations vary according to machine learning framework, programming language, runtime system, operating system, and/or underlying hardware resources. The underlying hardware resources variously include one or more computer systems, such as having any combination of Central Processing Units (CPUs), Graphics Processing Units (GPUs), Field Programmable Gate Arrays (FPGAs), Coarse-Grained Reconfigurable Architectures (CGRAs), Application-Specific Integrated Circuits (ASICs), Application Specific Instruction-set Processors (ASIPs), and Digital Signal Processors (DSPs), as well as computing systems generally, e.g., elements enabled to execute programmed instructions specified via programming languages. Various NN implementations are enabled to store programming information (such as code and data) on non-transitory computer readable media and are further enabled to execute the code and reference the data according to programs that implement NN architectures.

Examples of machine learning frameworks, platforms, runtime environments, and/or libraries, such as enabling investigation, development, implementation, and/or deployment of NNs and/or NN-related elements, may include TensorFlow, Theano, Torch, PyTorch, Keras, MLpack, MATLAB, IBM Watson Studio, Google Cloud AI Platform, Amazon SageMaker, Google Cloud AutoML, RapidMiner, Azure Machine Learning Studio, Jupyter Notebook, and/or Oracle Machine Learning.

The server subsystem 704 may be implemented to train one or more NNs. Example techniques to train NNs, such as to determine and/or update parameters of the NNs, include backpropagation-based gradient update and/or gradient descent techniques, such as Stochastic Gradient Descent (SGD), synchronous SGD, asynchronous SGD, batch gradient descent, and/or mini-batch gradient descent. The backpropagation-based gradient techniques are usable alone or in any combination (e.g., stochastic gradient descent may be usable in a mini-batch context). Example optimization techniques usable with (e.g., backpropagation-based gradient techniques (such as gradient update and/or gradient descent techniques)) may include Momentum, Nesterov accelerated gradient, Adagrad, Adadelta, RMSprop, Adam, AdaMax, Nadam, and/or AMSGrad.

Each client device 708 may generate, store, receive, and/or send digital data. In particular, the client device 708 may receive sequencing metrics from a sequencing device. Furthermore, the client device 708 may communicate with the server device(s) 702 to receive one or more files comprising nucleotide base calls and/or other metrics. The client device 708 may present or display information pertaining to the nucleotide-base call within a graphical user interface to a user associated with the client device 708.

The client device(s) 708 illustrated in FIG. 7 may comprise various types of client devices. In examples, the client device 708 may include non-mobile devices, such as desktop computers and/or servers, and/or other types of client devices. In other examples, the client device 708 may include mobile devices, such as laptops, tablets, mobile telephones, and/or smartphones.

As further illustrated in FIG. 7, each client device 708 may include a client subsystem 714. The client subsystem 714 may include software and/or hardware utilized by the client device 708 for processing sequencing requests and/or data, as described herein. The client subsystem 714 may span multiple layers of software and/or hardware. The client subsystem 714 may be included in a single client device 708 or may be distributed across multiple client devices 708.

The client subsystem 714 and/or the imaging system 710 may comprise a sequencing application. The sequencing application may be a web application and/or a native application stored and/or executed on the client device 708 (e.g., a mobile application, desktop application). The sequencing application may include instructions that (e.g., when executed) cause the client device 708 to receive data from a sequencing device and/or the server device(s) 702 and/or present, for display at the client device 708, data to the user of the client device 708.

Multiple client devices 708 may transmit requests from the client subsystem 714 to the server subsystem 704 for performing sequencing services. The client devices 708 that are transmitting the requests may operate using different versions of a sequencing application for analyzing sequencing data. In one example, the different versions of sequencing applications may support different types of analysis for the same or different types of sequencing devices. The server subsystem 704 of the server device 702 may load and/or execute different versions of a sequencing system to support client sequencing applications operating on different versions of software at the client subsystem 714. The different versions of the sequencing system may span multiple layers of software and/or hardware of the server subsystem 704. For example, the different versions of the sequencing system may span multiple software and/or hardware layers of a vertical solution stack.

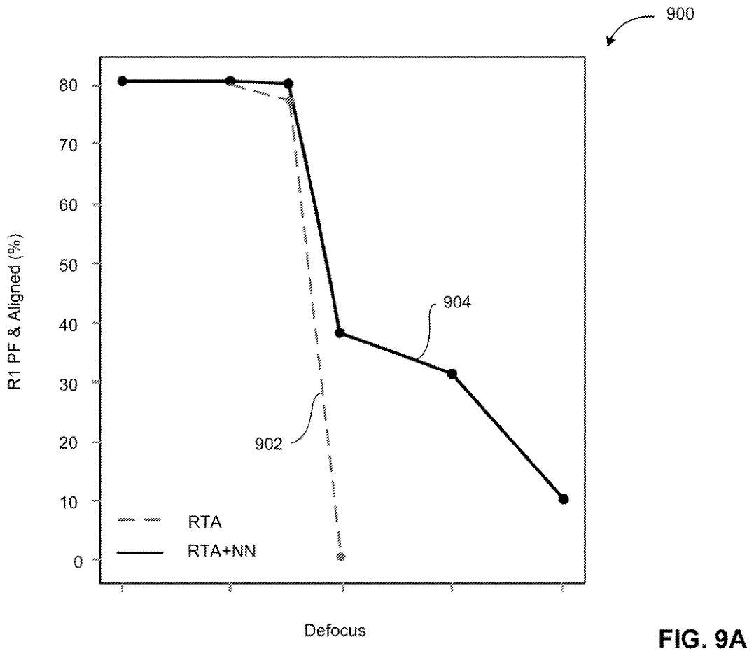

FIG. 8 illustrates an example of AI-driven aberration correction of sequencing images using a CNN-based image to image autoencoder model (e.g., using a U-Net architecture). The process may be performed by a server (e.g., the server device(s) 702). The process includes a training stage 802 and a production stage 804. Both of the training stage 802 and the production stage 804 include an encoder stage 806a, 806b and a decoder stage 808a, 808b. The encoder stages 806a, 806b comprises a plurality of layers, such as processing layers (e.g., convolutional layers), activation layers, and pooling layers of successively smaller dimensions, collectively enabled to compress representation of reduced power images to a relatively small representation (as illustrated conceptually by the Latent Variables element). The decoder stages 808a, 808b comprises layers (e.g., similar to those of the encoder stage) but dimensionally organized in “reverse” compared to the layers of the encoder stage, arranged in successively larger dimensions, so as to conceptually uncompress the latent variable information into a full-sized reconstructed image (e.g., corresponding to all or substantially all of a field of view of an imager) or alternatively a reconstructed image sized corresponding to input provided to the encoder stage (e.g., corresponding to one of a plurality of small patches of an image collected by an imager).

The encoder stage 806a of the training context 802 may receive images with spherical aberrations 810, process those images 810 as training data through the encoder stage 806a and the decoder stage 808a, and compare output of the decoder stage 808a with images that do not have spherical aberrations 812 using a loss function 814. The comparison of the loss function (e.g., Updates) may be fed back into training parameters (e.g., weights and biases) of the encoder and decoder stages 806a, 808a within the training context 802 to train and refine the aberration compensation model.

In the production context 804, the encoder stage 806b and the decoder stage 808b may be trained using the data from the encoder stage 806a and the decoder stage 808a of the training context 802. For example, trained parameters of the encoder/decoder filter information may be provided from the training encoder 806a and decoder 808a to the production encoder 806b and decoder 808b. The encoder stage 806b may receive production images with spherical aberrations 816, such as those generated by an imaging system (e.g., the imaging system 10 of FIG. 1), process those images 816 through a trained encoder stage 806b and a decoder stage 808b, and output images without spherical aberrations 818. Accordingly, the spherical aberration correction model of the production stage 804 (e.g., the trained encoder stage 806b and the decoder stage 808b) may be configured to correct for spherical aberrations that are the result of an imaging system (e.g., the imaging system 10 of FIG. 1). For instance, the reconstructed image 818 may correspond to an enhanced image with quality corresponding to that of an image without spherical aberrations. During training, the parameters of the encoder and the decoder stages are updated to effectively represent information salient to the enhancing. All or any portions of the parameters at completion of the training are referred to as filters.

In some examples, the autoencoder model includes one or more skip connections that allow feature representations, e.g., lower frequency content data, to pass through any particular layer for which further processing is inappropriate or unnecessary.

In some implementations, the training encoder stage 806a (e.g., such as embodied in a laboratory instrument) may be distinct from the production encoder stage 806b (e.g., such as embodied in a production instrument). In some implementations, the training encoder stage 806a may be used after training as the production encoder 806b, and the trained encoder/decoder filter information may be used in situ for production (e.g., an instrument is used as a dual-purpose laboratory instrument and production instrument).

In various implementations, performance of neural networks (NNs) may be improved by having x and y input dimensions equal to or approximately equal to x and y output dimensions. Another improvement may be achieved by increasing z input dimension (e.g., by number of images and/or channels input, and/or additional encoding, such as distance to nearest cluster center). Another improvement may be achieved by collecting and using information from images from multiple sequencing cycles. Other improvements include normalizing whole images (e.g., instead of sub-images). For various implementations of CNN-based NNs, performance may be improved by using depthwise convolutions, inverted bottlenecks, separating downsampling layers (e.g., instead of a 3×3 convolution with stride two, explicit downsampling with a 2×2 convolution with stride two), increasing kernel sizes, preferentially using layer normalization instead of batch normalization, preferentially using GELU instead of ReLU, and/or reducing layers used (e.g., fewer activation layers and/or fewer normalization layer). For various implementations of transformer based NNs, performance is improved by shifting windows between attention blocks to enable encoding spatial information between patches.

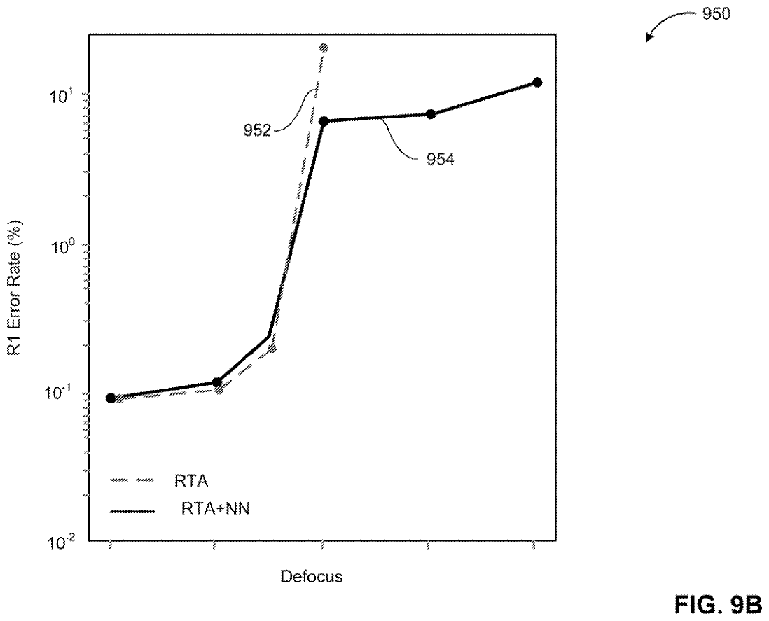

FIGS. 9A and 9B illustrate example results of base calling based on various levels of defocus. In FIG. 9A, the diagram 900 indicates throughput (e.g., a percentage of reads that pass filter and align to a reference genome). In FIG. 9B, the diagram 950 indicates quality (e.g., the error rate calculated after alignment to a reference genome). The run time assurance (RTA) line 902 illustrates the percentage of successful base calls that can be achieved using a base calling algorithm at various micrometers (μm) of defocus (e.g., FIG. 9A), while the RTA line 952 illustrates the percent error rate in base calling that can be achieved using a base calling algorithm at various micrometers of defocus (e.g., FIG. 9B). The RTA+NN line 904 illustrates the percentage of successful base calls that can be achieved using an aberration compensation model prior to the base calling algorithm at various micrometers of defocus (e.g., FIG. 9A), while the RTA+NN line 954 illustrates the percent error rate in base calling that can be achieved using the aberration compensation model prior to the base calling algorithm at various micrometers of defocus (e.g., FIG. 9B).

As illustrated, the use of the base calling model alone may result in base calls being unable to be performed beyond a defocus threshold of 0.75 μm (e.g., as shown by the RTA lines 902 and 952 in in FIG. 9A and FIG. 9B). However, when an aberration compensation model is used with the base calling algorithm, roughly 40% of otherwise failed base calls may be recovered at a defocus threshold of 1.0 μm (e.g., as shown by the RTA+NN lines 904 and 954 in FIGS. 9A and 9B). Further, at 2 μm of defocus, the use of the aberration compensation model with the base calling algorithm may result in some (e.g., a small but significant proportion) of reads that can be base called, and which are otherwise unbase-callable when the aberration compensation model is not used.

In some examples, the aberration compensation model may be trained to estimate and/or measure defocus in an image. A detector and/or equalizer may estimate and/or measure defocus in the image data of one or more surfaces of the support structure. For instance, the aberration compensation model may estimate the amount of defocus in the image data, and use the amount of defocus to generate a reconstructed image that does not include spherical aberrations. In some examples, one or more coefficients (e.g., the first coefficients and/or the second coefficients) may be trained for one or more levels and/or ranges of defocus.

The level and/or range or defocus may be as large as an optical field of view (FOV) and/or tile. In some examples, the processor may be configured to divide the FOV and/or tile into defocus subregions, for example, to determine a median defocus of each defocus subregion. The median defocus may be used by the aberration compensation model to estimate and/or measure the defocus in an image. Further, in some instances, there may be tilt and/or curvature in a flow cell which may lead to spatially varying defocus. Defocus subregions may be useful in correcting issues due to tilt and/or curvature.

In some embodiments, one or more focus tracking dots may be used to measure focus at different points in the FOV. A difference in focus between a pair of points may provide an estimate of tilt and/or curvature. The processor may be configured to generate a spatial defocus map based on the difference in focus, the median defocus, the level and/or range of defocus (e.g., and the coefficients). In some examples, the processor may generate the spatial defocus map before sequencing. The spatial defocus map may be updated during sequencing. This may account for perturbations such as objective heating, for example.

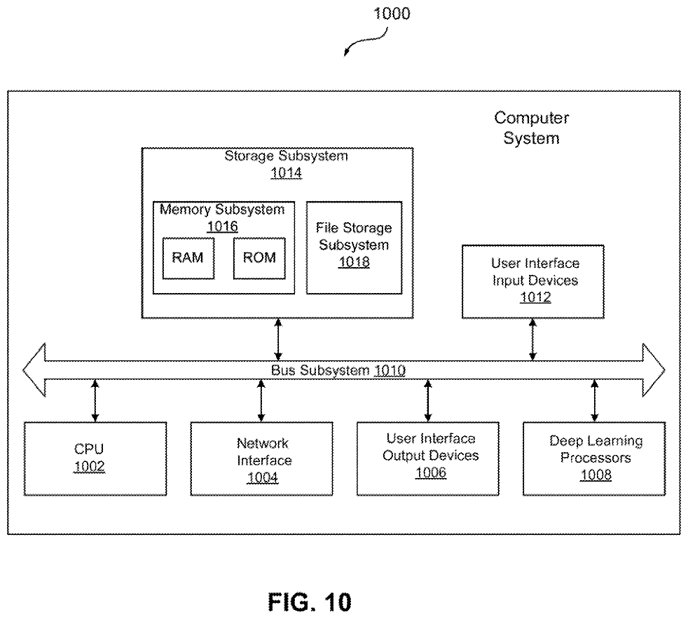

FIG. 10 is a block diagram of an example computer system 1000. The computer system 1000 may be an example of a control/processing system of a sequencing device/imaging system (e.g., the control/processing system 38 of FIG. 1), an imaging system (e.g., imaging system 710 of FIG. 7), a server device (e.g., server device 702 of FIG. 7), a client device (e.g., client device 708 of FIG. 7), and/or another computing device.

The computer system may comprise one or more of a storage subsystem 1014, user interface input devices 1012, a processor (e.g., central processing unit (CPU)) 1002, a network interface 1004, user interface output devices 1006, and one or more deep learning processors 1008 (e.g., such as a GPU, a FPGA, and/or a CGRA) interconnected by a bus subsystem 1010. The storage system 1014 may comprise a memory subsystem 1016 and/or a file storage subsystem. The memory subsystem 1016, for example, may comprise Randomly Accessible read/write Memory (RAM) and/or Read Only Memory (ROM). The ROM and/or file storage subsystem elements may comprise non-transitory computer readable media capabilities (e.g., for storing and executing programmed instructions to implement all or any portions of NN sections described herein). One or more memory subsystems may include one or more computer-readable storage media having computer-executable instructions stored thereon that, when executed by one or more processors, may be implemented to perform as described herein. The deep learning processors 1008 may be enabled, according to various implementations, to implement all or any portions of NN sections described herein, such as the training and/or use of a spherical aberration compensation model. In various implementations, the deep learning processors 1008 element may comprise various combinations of CPUs, GPUs, FPGAs, CGRAs, ASICs, ASIPs, and/or DSPs. Though illustrated as being implemented on a single computer system, one or more computing systems, or portions thereof, may be implemented for storing and executing programmed instructions to implement one or more embodiments described herein.

In various implementations, one or more of the laboratory instruments and/or the production instruments described herein comprise one or more computer systems identical to or similar to the example computer system 1000. In various implementations, any one or more of the training and/or production contexts may use any one or more computer systems identical to or similar to the example computer system 1000 to perform NN-related processing and/or operation (e.g., as one or more servers relating to training data collection and/or synthesis, as well as production data collection and/or processing, such as image enhancement).

In various implementations, the memory subsystem 1016 and/or the file storage subsystem 1018 may be enabled to store parameters of NNs, such as all or any portions of parameters of NN sections described herein. For example, all or any portions of the stored parameters may variously correspond to any combination of initialized parameters of a NN used in a training context, trained parameters of the NN used in the training context, and/or trained parameters of a NN used in a production context. For another example, all or any portions of the stored parameters may correspond to one or more intermediate representations, such as relating to information that is provided by a training context to a production context, as illustrated and described herein, for example.

In some embodiments, at least some of the stored parameters may correspond to information provided by the training NN Generator (G) to the production NN Generator (G). In some examples, at least some of the stored parameters may correspond to information retained in the generator stage after training in the training context for use in production in the production context. In some examples, at least some of the stored parameters may correspond to information provided by the training context to the production context. In some examples, at least some of the stored parameters may correspond to information provided by the training context to the production context.

In various implementations, a controller may comprise one or more elements similar to the computer system 1000, such as for example to store and/or execute programmed instructions to implement all or any portions of NN sections described herein and/or to store parameters of NNs.

The processor 1002 may be configured to perform a sequencing operation and/or determine base calls from one or more images generated by an imaging system. For example, the processor 1002 may be configured to determine base calls of irradiated sites that fluoresce within one or more of the first emissive component and the second emissive component of the support structure. In some embodiments, the processor 1002 may be configured to receive images of a plurality of surfaces of a support structure that include spherical aberrations, and determine base calls using an aberration compensation model applied to the images. Alternatively or additionally, the processor 1002 may be configured to generate a reconstructed version of the images that do not include spherical aberrations, and determine base calls using an aberration compensation model applied to the reconstructed version of the images.

The processor 1002 may be configured to generate one or more of a first reconstructed image of the first image data using and a second reconstructed image of the second image data using the aberration correction model. For example, the aberration correction model may compensate for aberrations in one or more of the first image and the second image. In some embodiments, the processor 1002 may be configured to determine one or more of base calls of the irradiated sites that fluoresce within the first emissive component of the support structure and base calls of the irradiated sites that fluoresce within the second emissive component of the support structure. For example, the processor 1002 may use a base call algorithm. In some embodiments, the base call algorithm may comprise the aberration compensation model. For example, the processor 1002 may be configured to generate an aberration compensation model using one or more of decoding, deep learning, deep Fourier channel attention network (DFCAN), optical transfer function (OTF) inversion, point spread function (PSF), iterative deconvolution, linear deconvolution, or nonlinear deconvolution (e.g., Lucy-Richardson). In some embodiments, the processor 1002 may be configured to generate one or more of the first image and the second image without the use of a corrective compensator component. For example, the imaging system may not include a corrective compensator component. In some embodiments, image reconstruction may be performed (e.g., by deep learning). For example, an intermediate image may be generated. Base calling may be performed based on one or more of the intermediate image, first image data, and/or second image data.

The aberration compensation model may include one or more of first coefficients to compensate for the aberrations of the first image data, and second coefficients to compensate for the aberrations of the second image data. For example, the first coefficients may be based on a distance between a point of focus of the focusing optics and the first surface of the support structure. The second coefficients may be based on a distance between the point of focus of the focusing optics and the second surface of the support structure in some examples.

Additionally or alternatively, one or more aberrations may be at least partially removed using an equalizer. For example, the equalizer may be configured to filter crosstalk at a cluster from one or more adjacent cluster. In some embodiments, an aberration may be removed and/or a biological sample may be base called as in U.S. Pat. No. 11,188,778, which is hereby incorporated by reference.

Additionally, or alternatively, examples described herein may incorporate a spatial equalizer for performing signal enhancement, as further described in U.S. Pat. No. 11,188,778, which is hereby incorporated by reference. An equalizer may be trained to generate and/or implement look-up tables (LUTs). The equalizer may generate a LUT bank with a plurality of LUTs (e.g., equalizer filters). Each LUT may have a plurality of coefficients that are learned from the training. In one implementation, the number of coefficients in a LUT corresponds to the number of image pixels. For example, if a local grid of image pixels is of size p×p (e.g., 9×9 pixel patch), then each LUT has p² coefficients (e.g., 81 coefficients).

The coefficients of the equalizer may be trained using supervised training according to one or more embodiments described herein. For example, the equalizer may be trained using paired images, such as a high-resolution target image and low-resolution training images. The equalizer may receive low-resolution training image data as input and the coefficients may be trained based on the high-resolution target image in the image pair. Examples of the training techniques for the equalizer may include least squares estimation, ordinary least squares, least-mean squares, and recursive least-squares. The least squares technique adjusts the parameters of a function to best fit a data set so that the sum of the squared residuals is minimized.

In one implementation of the training, low-resolution training data from the sequencing images may be binned (e.g., by well subpixel location). For example, for a 5×5 LUT, 1/25^{th} of the wells have a center that is in bin (1,1) (e.g., the upper left corner of a sensor pixel), 1/25^{th} of the wells are in bin (1,2), and so on. The input to the equalizer may be the pixels of the low-resolution images for those bins. The resulting estimated equalizer coefficients are different per bin.

Each LUT may have a plurality of coefficients that are learned from the training. In one implementation, the number of coefficients in a LUT may correspond to a number of image pixels. For example, if a local grid of image pixels (image or pixel patch) is of size p×p (e.g., 9×9 pixel patch), then each LUT may have p² coefficients (e.g., 81 coefficients).

The training of the equalizer may produce equalizer coefficients that are configured to mix/combine intensity values of pixels that depict intensity emissions for a target image or image cluster and/or intensity emissions from one or more adjacent clusters in a manner that maximizes a signal-to-noise ratio. The signal maximized in the signal-to-noise ratio may be the intensity emissions from the target image, and the noise minimized in the signal-to-noise ratio is the intensity emissions from the adjacent clusters, i.e., spatial crosstalk, plus some random noise (e.g., to account for background intensity emissions). The equalizer coefficients may be used as weights and the mixing/combining may include executing element-wise multiplication between the equalizer coefficients and the intensity values of the pixels to calculate a weighted sum of the intensity values of the pixels. During production, the equalizer may receive low-resolution image data as input and interpolate the image using the coefficients that have been trained using the high-resolution image data to generate a high-resolution image.

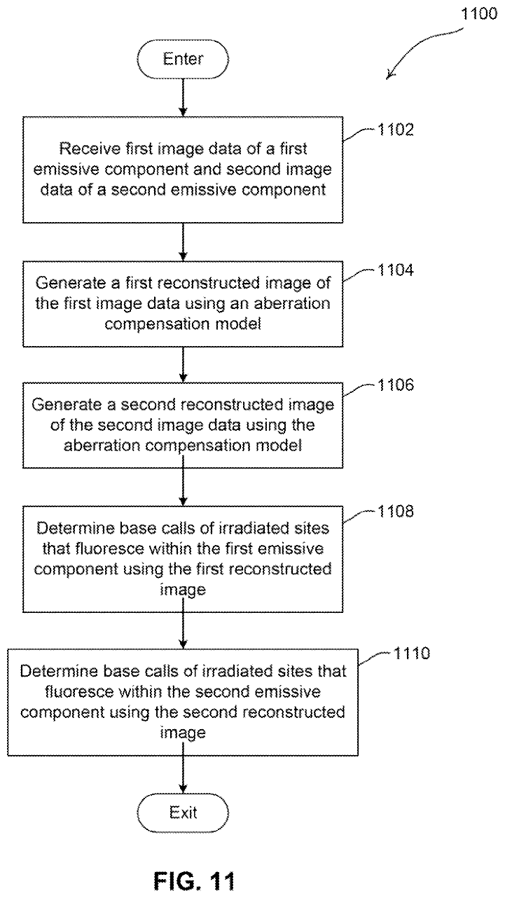

FIG. 11 is a flow diagram of an example procedure 1100 for determining base calls of irradiated sites that fluoresce within the emissive components of the support structure using an aberration compensation model. The procedure 1100 may be performed by a processor of a system, such as the processor of a server device (e.g., the server device(s) 702 and/or one or more processors, such as the processor 1002 of the computer system 1000 of FIG. 10). The processor may be configured to perform the procedure 1100 to perform base calls of biological samples that are located on multiple surfaces of a support structure, such as the first biological sample 12 present on the first surface 18 of the support structure 16 and the second biological sample 14 present on the second surface 20 of the support structure 16. As noted herein, radiation emissions may be emitted by the biological samples, and the imaging system may be configured to generate images of the first emissive component and the second emissive component based on the detected radiation. The imaging system may have a high numerical aperture (e.g., at least 0.6 in some examples, at least 0.75 in some other examples, or at least 0.85 in some examples) and/or may not include a corrective compensator component. Further, some support structures include a fluid layer between the first and second surfaces (e.g., the first and second biological samples). Therefore, the images captured by the imaging system of the first and second surfaces may have spherical aberrations (e.g., and the spherical aberrations may be different between the two surfaces). As noted above, the spherical aberrations may limit the ability of the processor to accurately base call the biological samples located on the first and second surfaces (e.g., differentiate the nucleotides channels A, C, G and T). Accordingly, the processor may perform the procedure 1100 to more accurately base call the biological samples based on images that were generated with spherical aberrations.

At 1102, the processor may receive first image data of a first emissive component that resides on a first surface of the support structure (e.g., the first biological sample 12 present on the first surface 18 of the support structure 16), and a second image data of a second emissive component that resides on a second surface of the support structure (e.g., the second biological sample 14 present on the second surface 20 of the support structure 16). The processor may receive the first and second image data from an imaging system. The first and second image data may include spherical aberrations, for example, for the reasons noted herein. In some examples, the image data may include an intensity for an irradiated site. As described herein, the imaging system may include a detector (e.g., the detector 36) that is configured to generate the image data. In some embodiments, the detector may be configured to generate image data of the first emissive component when focusing optics (e.g., the focusing optics 32) confocally directs radiation to the first emissive component, and/or generate image data of the second emissive component when the focusing optics confocally directs radiation to the second emissive component.

At 1104, the processor may be configured to generate a first reconstructed image of the first image data using the aberration compensation model, for example, to correct any spherical aberrations that reside within the first image data. As such, the first reconstructed image data may not include any spherical aberrations, which as noted above, may improve the ability of the processor to base call the biological sample on the first surface of the support structure.

At 1106, the processor may be configured to generate a second reconstructed image of the second image data using the aberration compensation model, for example, to correct any spherical aberrations that reside within the second image data. As such, the second reconstructed image data may not include any spherical aberrations, which as noted above, may improve the ability of the processor to base call the biological sample on the second surface of the support structure.

In some examples, the aberration compensation model may include first coefficients to compensate for the aberrations of the first image data when generating the first reconstructed image, and use second coefficients to compensate for the aberrations of the second image data when generating the second reconstructed image. The first coefficients may be based on a distance between a point of focus of the focusing optics and the first surface of the support structure, while the second coefficients may be based on a distance between the point of focus of the focusing optics and the second surface of the support structure.

At 1108, the processor may determine base calls of irradiated sites that fluoresce within the first emissive component using the first reconstructed image. For example, the processor may perform base calls on the biological samples that are disposed on the first surface of the support structure using the first reconstructed image (e.g., which itself was generated using the aberration compensation model). Similarly, at 1110, the processor may determine base calls of irradiated sites that fluoresce within the second emissive component using the second reconstructed image. For example, the processor may perform base calls on the biological samples that arc disposed on the second surface of the support structure using the second reconstructed image (e.g., which itself was generated using the aberration compensation model). Accordingly, the processor may be configured to accurately base call images that have a spherical aberration outside of a particular range by, for example, generating reconstructed images that do not include the spherical aberrations using the aberration compensation model and performing a base call on the reconstructed images. As such, the processor may be configured to determine base calls from images that have spherical aberrations that were otherwise not achievable. Using the procedure 1100, the processor may generate one or more reconstructed images of the images of the plurality of surfaces of the support structure using the aberration compensation model, and then determine the base calls using the reconstructed images.

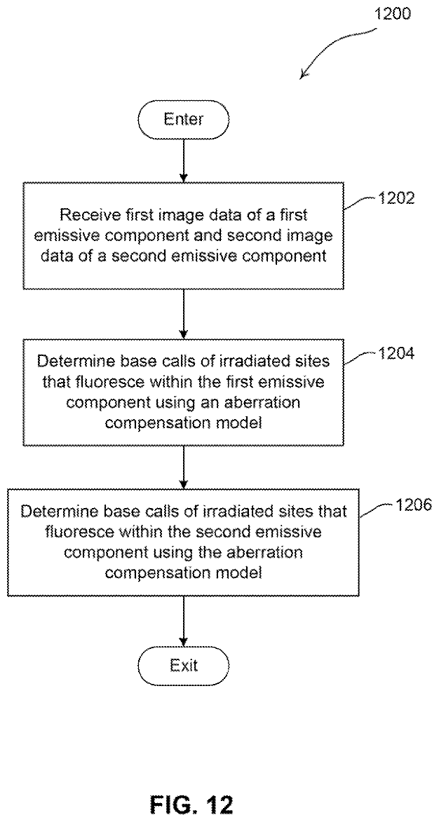

FIG. 12 is a flow diagram of an example procedure 1200 for determining base calls of irradiated sites that fluoresce within the emissive components associated with the support structure using an aberration compensation model. The procedure 1200 may be performed by a processor of a system, such as the processor of a server device (e.g., the server device(s) 702 and/or one or more processors, such as the processor 1002 of the computer system 1000 of FIG. 10). The processor may be configured to perform the procedure 1200 to perform base calls of biological samples that are located on multiple surfaces of a support structure, such as the first biological sample 12 present on the first surface 18 of the support structure 16 and the second biological sample 14 present on the second surface 20 of the support structure 16 shown in FIG. 1. As noted herein, the images captured by the imaging system of the first and second surfaces may have spherical aberrations (e.g., and the spherical aberrations may be different between the two surfaces), and the spherical aberrations may limit the ability of the processor to accurately base call the biological samples located on the first and second surfaces (e.g., differentiate the nucleotides channels A, C, G and T). Accordingly, the processor may perform the procedure 1200 to more accurately base call the biological samples based on images that were generated with spherical aberrations. Further, as described below, the processor may be configured to determine a base call directly from one or more of the first image data and the second image data (e.g., which include spherical aberrations) using the procedure 1200 (e.g., and without generating reconstructed images prior to base calling, as was done in the procedure 1100). For example, the aberration compensation model may be part of a base call algorithm performed by the processor when performing the procedure 1200.

At 1202, the processor may receive first image data of a first emissive component that resides on a first surface of the support structure (e.g., the first biological sample 12 present on the first surface 18 of the support structure 16 shown in FIG. 1), and a second image data of a second emissive component that resides on a second surface of the support structure (e.g., the second biological sample 14 present on the second surface 20 of the support structure 16 shown in FIG. 1). The processor may receive the first and second image data from an imaging system. The first and second image data may include spherical aberrations, for example, for the reasons noted herein. In some examples, the image data may include an intensity for an irradiated site. As described herein, the imaging system may include a detector (e.g., the detector 36 shown in FIG. 1) that is configured to generate the image data. In some embodiments, the detector may be configured to generate image data of the first emissive component when focusing optics (e.g., the focusing optics 32 shown in FIG. 1) confocally directs radiation to the first emissive component, and/or generate image data of the second emissive component when the focusing optics confocally directs radiation to the second emissive component.

At 1204, the processor may determine base calls of irradiated sites that fluoresce within the first emissive component using the first image and the aberration compensation model (e.g., and without generating a reconstructed first image). The aberration compensation model may be part of a base call algorithm performed by the processor. For example, the aberration compensation model may be part of an equalizer that includes a spatial sharpening mask. The spatial sharpening mask may consider features of the first surface of the support structure (e.g., nanowell locations), chemistry (e.g., number of dyes), etc. The aberration compensation model may determine different coefficients for different levels of defocus of the first image. In some instances, using the aberration compensation model on (e.g., directly on) the first image data may require an independent measurement of defocus of the first image. The processor (e.g., using the equalizer) may receive the first image and output the intensities at each known nanowell location on the first surface of the support structure. The processor may then convert the intensities to base calls at 1204.

Similarly, at 1206, the processor may determine base calls of irradiated sites that fluoresce within the second emissive component using the second image and the aberration compensation model (e.g., and without generating a reconstructed second image). For example, the aberration compensation model may be part of an equalizer that includes a spatial sharpening mask. The spatial sharpening mask may consider features of the second surface of the support structure (e.g., nanowell locations), chemistry (e.g., number of dyes), etc. The aberration compensation model may determine different coefficients for different levels of defocus of the second image. In some instances, using the aberration compensation model on (e.g., directly on) the second image data may require an independent measurement of defocus of the second image. The processor (e.g., using the equalizer) may receive the second image and outputs the intensities at each known nanowell location on the second surface of the support structure. The processor may then convert the intensities to base calls at 1206. Accordingly, using the procedure 1200, the processor may be configured to determine a base call directly from one or more of the first image data and the second image data (e.g., which include spherical aberrations) using the aberration compensation model (e.g., and without generating reconstructed images prior to base calling).

Though embodiments may be described herein as being performed by a processor configured to perform as described herein, one or more processors may be implemented on one or more computing devices to be implemented to perform as described herein.

What is claimed is:

1. An imaging system for detecting radiation emissions on a support structure, the imaging system comprising:
an optical train comprising imaging optics, wherein the imaging optics are configured to focus the optical train towards a support structure, wherein the support structure comprises a first emissive component associated with a biological sample disposed on a first surface of the support structure, and a second emissive component associated with the biological sample disposed on a second surface of the support structure;
an excitation radiation source configured to direct excitation radiation towards the first and second emissive components;
detection optics configured to detect radiation emissions returned from the first and second emissive components via the optical train;
a detector configured to generate first image data of the first emissive component based on the detected radiation emissions and second image data of the second emissive component based on the detected radiation emissions; and
a processor configured to:
determine base calls of irradiated sites that fluoresce within the first emissive component of the support structure using an aberration compensation model; and
determine base calls of irradiated sites that fluoresce within the second emissive component of the support structure using the aberration compensation model, wherein the aberration compensation model is trained to compensate for aberrations of the first image data and to compensate for aberrations of the second image data.

2. The imaging system of claim 1, wherein the processor is configured to:
generate a first reconstructed image of the first image data using the aberration compensation model to compensate for the aberrations of the first image, and generate a second reconstructed image of the second image data using the aberration compensation model to compensate for the aberrations of the second image; and
determine the base calls of the irradiated sites that fluoresce within the first emissive component of the support structure using the first reconstructed image, and determine the base calls of the irradiated sites that fluoresce within the second emissive component of the support structure using the second reconstructed image.

3. The imaging system of claim 1, wherein the processor is configured to:
determine the base calls of the irradiated sites that fluoresce within the first emissive component of the support structure and the base calls of the irradiated sites that fluoresce within the second emissive component of the support structure using a base call algorithm, wherein the base call algorithm comprises the aberration compensation model.

4. The imaging system of claim 1, wherein the optical train further comprises focusing optics, wherein the aberration compensation model comprises first coefficients to compensate for the aberrations of the first image data, and comprises second coefficients to compensate for the aberration of the second image data, and wherein the first coefficients are based on a distance between a point of focus of the focusing optics and the first surface of the support structure, and the second coefficients are based on a distance between the point of focus of the focusing optics and the second surface of the support structure.

5. (canceled)

6. (canceled)

7. The imaging system of claim 1, wherein the processor is configured to generate the first image and the second image without the use of a corrective compensator component.

8. The imaging system of claim 1, wherein the optical train further comprises focusing optics configured to confocally direct radiation to a surface of the support structure, and wherein the focusing optics is defined by a numerical aperture (NA) value of at least about 0.75.

9. The imaging system of claim 8, wherein the detector is configured to generate image data of the first emissive component when the focusing optics confocally directs radiation to the first emissive component, and generate image data of the second emissive component when the focusing optics confocally directs radiation to the second emissive component.

10. The imaging system of claim 8, wherein the focusing optics is configured for a single design point for diffraction-limited focusing and imaging, wherein the design point is located at one or more of the first surface, the second surface, and between the first surface and the second surface of the support structure.

11. (canceled)

12. (canceled)

13. The imaging system of claim 1, wherein the excitation radiation source is configured to direct the excitation radiation towards the first and second emissive components along a radiation line, and wherein the radiation line is configured to reside between the first and second emissive components.

14. The imaging system of claim 1, wherein the processor is configured to generate the aberration compensation model using one or more of deep learning, optical transfer function (OTF) inversion, iterative deconvolution, linear deconvolution, or nonlinear deconvolution.

15. The imaging system of claim 1, wherein the support structure is a multi-surface flow cell.

16. The imaging system of claim 1, wherein the first emissive component comprises a first nanowell pattern and the second emissive component comprises a second nanowell pattern, the first nanowell pattern different than the second nanowell pattern.

17. The imaging system of claim 1, wherein the optical train further comprises conditioning optics configured to generate a substantially linear excitation beam of radiation or combine excitation beams from excitation radiation sources.

18. The imaging system of claim 1, wherein the optical train further comprises directing optics configured to redirect an excitation beam from the excitation radiation source toward focusing optics.

19. The imaging system of claim 1, wherein the detector comprises a charged coupled device (CCD) sensor that is configured to generate the image data based upon photons impacting locations in the detector.

20. The imaging system of claim 1, wherein the detector comprises one or more of a detector array configured for time delay integration (TDI) operation, a complementary metal oxide semiconductor (CMOS) detector, an avalanche photodiode (APD) detector, and a Geiger-mode photon counter.

21. The imaging system of claim 1, further comprising:
a translation system configured to allow for focusing and movement of the support structure before and during imaging.

22. The imaging system of claim 1, wherein the imaging system comprises only a single excitation radiation source.

23. A method for detecting radiation emissions on a support structure, the method comprising:
receiving first image data of a first emissive component based on first detected radiation emissions and second image data of a second emissive component based on second detected radiation emissions, wherein a support structure comprises the first emissive component associated with a biological sample disposed on a first surface of the support structure, and the second emissive component associated with the biological sample disposed on a second surface of the support structure;
determining base calls of irradiated sites that fluoresce within the first emissive component of the support structure using an aberration compensation model; and
determining base calls of irradiated sites that fluoresce within the second emissive component of the support structure using the aberration compensation model, wherein the aberration compensation model is trained to compensate for aberrations of one or more of the first image data or the second image data.

24. (canceled)

25. (canceled)

26. At least one computer-readable storage medium comprising executable instructions that are configured to, when executed by at least one processor, cause the at least one processor to:
generate first image data of a first emissive component based on detected radiation emissions and second image data of a second emissive component based on the detected radiation emissions, wherein a support structure comprises the first emissive component associated with a biological sample disposed on a first surface of the support structure, and the second emissive component associated with the biological sample disposed on a second surface of the support structure;
determine base calls of irradiated sites that fluoresce within the first emissive component of the support structure using an aberration compensation model; and
determine base calls of irradiated sites that fluoresce within the second emissive component of the support structure using the aberration compensation model, wherein the aberration compensation model is trained to compensate for aberrations of the first image data and to compensate for aberrations of the second image data.

27. (canceled)

28. (canceled)
